(19) United States
(12) Patent Application Publication
(10) Pub. No.: US 2011/0050759 A1
(43) Pub. Date: Mar. 3, 2011

(54) DISPLAY DEVICE AND SCANNING LINE DRIVING DEVICE

(76) Inventors: Masafumi Katsutani, Osaka (JP); Yukihisa Orisaka, Osaka (JP); Takuya Watanabe, Osaka (JP)

(21) Appl. No.: 12/734,683

(22) PCT Filed: Nov. 12, 2008
(86) PCT No.: PCT/JP2008/070555

§ 371 Date: May 17, 2010

(30) Foreign Application Priority Data
Nov. 21, 2007 (JP) 2007-302291
Dec. 12, 2007 (JP) 2007-320840

(51) Int. Cl. G09G 5/02

(52) U.S. Cl. 345/694

(57) ABSTRACT

In a display device driven by multi-picture element driving, in order to realize narrowing of a frame, a gate driver provided in the display device includes buffers. Storage capacitor driving signals are inputted in the buffers. In at least one embodiment, once the storage capacitor driving signals are inputted, the buffers shape waveforms of the storage capacitor driving signals, and outputs the storage capacitor driving signals thus shaped to storage capacitor wires via terminals “CSVtypeA1′R” to “CSVtypeA4′R” and terminals “CSVtypeA1′L” to “CSVtypeA4′L”. The buffers supply storage capacitor driving signals reduced in waveform rounding as such, to drive a storage capacitor that is connected to the storage capacitor wires.

### TECHNICAL FIELD

The present invention relates to a display device or the like used in for example a word processor, personal computer, and receiver of a television broadcast. Particularly, the present invention relates to a display device of an active matrix liquid crystal display device or the like, and a scanning line driving device for driving scanning lines that are provided in the display device.

### BACKGROUND ART

Liquid crystal display devices are flat display devices having excellent advantages such as high definition, thin thickness, lightweight, and low power consumption. Along with the improvement in displaying abilities, productivity and price competitiveness against other display devices, the liquid crystal display device market has been rapidly expanding in its scale.

Under the progressing situation in improvement of display quality, problems regarding viewing angle characteristics have become newly revealed with the liquid crystal display devices, such as a problem of viewing angle dependence of gamma characteristics, which is a tone dependence of display luminance, for example excess brightness.

The problem of the viewing angle dependence of gamma characteristics is that the gamma characteristics in a case where the display device is observed from a front direction vary from that in a case where the display device is observed from an oblique direction. The difference in gamma characteristics between that observed from the front direction and that observed from the oblique direction implies that in what tone a display is carried out differs depending on the direction from which the display device is observed. This problem of the viewing angle dependence of gamma characteristics becomes particularly a large problem in cases where an image such as a photo or the like is to be displayed, and also in a case where television broadcast that is received by a receiver is displayed.

As a technique to overcome the problem of the viewing angle dependence of the gamma characteristics, a technique called multi-picture element driving is conventionally available (see Patent Literature 1). In the multi-picture element driving, one display picture element is made up by dividing the display picture element into at least two sub-picture elements that have different luminance, in order to improve the viewing angle characteristics, i.e., the viewing angle dependence of the gamma characteristics.

The following description explains a principle of the multi-picture element driving, with reference to FIGS. 11 to 16.

FIG. 11 is a graph showing gamma characteristics of a liquid crystal display panel in a liquid crystal display device. In the graph of FIG. 11, the vertical axis represents a luminance ratio, and the horizontal axis represents tone (voltage). In the graph of FIG. 11, characteristics shown by the solid line is a gamma characteristic of a liquid crystal display panel driven by a normal driving method, which liquid crystal display panel is observed from a front direction. With such a gamma characteristic, a most normal visibility is obtained. The normal driving method in this specification denotes a driving method in which no display picture element is divided into a plurality of sub-picture elements. In the graph of FIG. 11, characteristics shown by the broken line is a gamma characteristic of the liquid crystal display panel driven by the normal driving method, which liquid crystal display panel is observed from an oblique direction. With such a gamma characteristic, the gamma characteristic comes off from that of the normal visibility. The degree in which the gamma characteristic comes off is small at a part where the luminance ratio is near 0 or 1, and is large at a part where the luminance ratio is far from 0 or 1. That is to say, the degree in which the gamma characteristic comes off is small at parts showing a light luminance and a dark luminance, and is large at a part showing a halftone. Thus, display luminance in halftone that is visible from the oblique direction becomes extremely great. As a result, excess brightness or the like occurs when the liquid crystal display device is observed from an oblique direction.

On the other hand, the multi-picture element driving controls driving of the picture element so that an average of the luminance of the plurality of sub-picture elements that makes up one display picture element calculates to meet a target luminance of the one display picture element. Gamma characteristics of the multi-picture element driving in a case where the display is observed from a front direction are similar to that of the normal driving method. That is to say, the display driven by multi-picture element driving that is observed from a front direction has the gamma characteristics shown by the solid line in the graph of FIG. 11, thereby obtaining a most normal visibility. In comparison, when the display driven by the multi-picture element driving is observed from an oblique direction, the display has a gamma characteristic shown by the alternate long and short dash line in the graph of FIG. 11. As shown, the difference in luminance is reduced. This is because areas near the light luminance and dark luminance which have the small difference in luminance are displayed per sub-picture element, and areas having the halftone luminance are displayed by an average luminance of the sub-picture elements.

Next, FIG. 12 illustrates a configuration example of a display picture element of a liquid crystal display device driven by the multi-picture element driving.

As shown in FIG. 12, one display picture element 120 is divided into a plurality of sub-picture elements: sub-picture elements 121 and 122. The sub-picture element 121 is connected to a scanning line Gn and a signal line Sm via a TFT (Thin Film Transistor) 123, and the sub-picture element 122 is connected to the scanning line Gn and the signal line Sm via a TFT 124. Gate electrodes of the TFT 123 and TFT 124 are connected to a common (identical) scanning line Gn. Moreover, source electrodes of the TFT 123 and TFT 124 are connected to a common (identical) signal line Sm.

The sub-picture element 121 has a liquid crystal capacitor CLC100 and a storage capacitor CCS100. The liquid crystal capacitor CLC100 and storage capacitor CCS100 both have one of their electrodes connected to a drain electrode of the TFT 123. The liquid crystal capacitor CLC100 has the other one of its electrodes connected to a counter voltage VCOM100. The storage capacitor CCS100 has the other one of its electrodes connected to a storage capacitor wire 125. By having such a connection, a storage capacitor counter voltage (hereinafter referred to as CS voltage) is applied to the storage capacitor CCS100 via the storage capacitor wire 125.

The sub-picture element 122 has a liquid crystal capacitor CLC101 and a storage capacitor CCS101. The liquid crystal capacitor CLC101 and storage capacitor CCS101 both have one of their electrodes connected to a drain electrode of the TFT 124. The liquid crystal capacitor CLC101 has the other one of its electrodes connected to a counter voltage VCOM101. The storage capacitor CCS101 has the other one of its electrodes connected to a storage capacitor wire 126. By having such a connection, a CS voltage different from the CS voltage supplied to the storage capacitor CCS100 is applied to the storage capacitor CCS101 via the storage capacitor wire 126.

FIG. 13 illustrates one example of waveforms of the source voltage and the CS voltage, which are applied to the sub-picture elements 121 and 122, respectively, in the display picture element 120 illustrated in FIG. 12.

In the display picture element 120 arranged as in the configuration illustrated in FIG. 12, different CS voltages are respectively applied to the divided plurality of sub-picture elements 121 and 122. Thus, the voltage applied to the drain electrode of the TFT 123 is a voltage different from the voltage applied to the drain electrode of the TFT 124. This makes tones displayed in the sub-picture elements 121 and 122 to also be different from each other. In this case, the CS voltage is driven by AC (alternating current). More specifically, although the source electrodes of the TFT 123 and TFT 124 are turned ON at a same gate timing, since the voltages of the CS electrodes (that is, the storage capacitors CCS100 and CCS101) connected to the drain electrodes of the TFT 123 and TFT 124 are different from each other, the voltages that are actually retained in the TFT 123 and TFT 124 differ from each other. Hence, display of a different luminance, that is, a different tone, becomes realizable with the sub-picture elements 121 and 122.

The CS voltage of the storage capacitor wire 125 and the CS voltage of the storage capacitor wire 126 have a substantially identical amplitude and frequency, and their phases differ by around 180 degrees, each as shown in FIG. 13. Moreover, in a subsequent frame, the CS voltage inverts in time with inversion of the source voltages of the TFT 123 and TFT 124. As such, the CS voltage is driven by AC.

Here, a voltage Va applied to the sub-picture element 121 and a voltage Vb applied to the sub-picture element 122 satisfies the following equation (1) with respect to an applied voltage Vm that represents a target luminance:

Vm=(Va+Vb)/2 (1)

Hence, it is clear that the target luminance is obtained by averaging the display luminance of the sub-picture elements 121 and 122.

Moreover, Patent Literature 2 discloses a technique in which inversion of a CS voltage is carried out in a longer cycle than a frame cycle, in a high definition liquid crystal display panel having a short horizontal scanning period.

In the high definition liquid crystal display panel, as the horizontal scanning period shortens, the number of storage capacitor increases. With such a liquid crystal display panel, rounding occurs to waveforms of storage capacitor driving signals for applying the CS voltage. The degree of the waveform rounding varies within in the liquid crystal display panel, so therefore an effective voltage to be applied to the sub-picture element electrode also varies within the liquid crystal display panel. This causes a problem with the liquid crystal display panel that unevenness of luminance in the display occurs.

In order to solve the problem, the technique disclosed in Patent Literature 2 provides a long CS voltage vibration period. As a result, the technique disclosed in Patent Literature 2 is successful in reducing the unevenness in luminance of the display.

For example, in a case where a waveform of the CS voltage is inverted per frame, there is a need to prepare two types of CS voltage waveforms that serve as the basis of respective voltages Va and Vb, as shown in FIG. 13.

Each of graphs in FIG. 14 illustrates an example in which a waveform of the CS voltage is inverted per two frames. In a case where the waveform of the CS voltage is inverted per two frames, there is a need to further prepare a CS voltage that has a waveform shifted in phase by one frame. Hence, as illustrated in the graphs of FIG. 14, it is necessary to prepare 4 types of CS voltages: “VCSVtypeA1” to “VCSVtypeA4”. Moreover, in this case, with the signal lines of the CS voltage on the liquid crystal display panel, a main wiring 151 made up of “CSVtypeA1” to “CSVtypeA4” is provided on both ends of the picture element and in a direction intersecting at right angles to storage capacitor wires 150, as illustrated in FIG. 15. Accordingly, the CS voltage is supplied to each of storage capacitors 152 via the storage capacitor wires 150 drawn out from the main wiring 151.

Moreover, FIG. 16 illustrates wiring of storage capacitor driving signals in a glass substrate of a liquid crystal display panel.

A liquid crystal display panel 160 has a glass substrate 161 on which (i) a source driver 162 that supplies display signals to the signal lines Sm and (ii) a gate driver 163 providing scanning line driving signals (scanning line signals) to the scanning lines Gn are mounted. Here, gate drivers 163A and 163B are mounted as the gate driver 163.

Signals that control the source driver 162, signals that control the gate driver 163, and the storage capacitor driving signals, are generated by a controller not illustrated, and are supplied to the source driver 162. Among these signals, the signals that control the gate driver 163 and the storage capacitor driving signals are provided to each of wires 165 on the glass substrate 161, via wires 164 provided on a package of the source driver 162. Furthermore, among these signals, the signals that control the gate driver 163 are provided to an input terminal of the gate driver 163A via the wires 165 on the glass substrate 161.

The gate driver 163A generates the scanning line driving signals, and provides the control signals (the signals that control the source driver 162 and the signals that control the gate driver 163) to the subsequent gate driver 163B.

The wires 165 provided on the glass substrate 161, which provide the storage capacitor driving signals, extend as core signal lines in a form of a core wiring 166, in a direction intersecting with scanning lines Gn. Further, the storage capacitor driving signals are provided to storage capacitors CCS via storage capacitor wires CSL drawn out from the core wiring 166. Reference signs included in FIG. 16 that have not been explained, i.e., “CLC” and “VCOM”, denote a liquid crystal capacitor and a counter voltage, respectively.

Furthermore, Patent Literature 3 discloses a liquid crystal driver mounting package as a method for mounting an LSI (Large Scale Integration) for driving such as a driving gate driver, in which a driver socket (so-called interposer substrate) made of for example silicon is used to broaden an output terminal having a narrow pitch. This liquid crystal driver mounting package is advantageous in that a base material (so-called, tape carrier) that relays connection between the LSI and the panel, does not need to have a narrow terminal pitch.

The following description explains this technique with reference to FIGS. 23 to 25.

FIG. 23 illustrates a top view of an IC chip mounting package according to Patent Literature 3 and a cross-sectional view taken on line G-G of the top view.

The IC chip mounting package according to Patent Literature 3 is characterized by its driver socket 701.

FIGS. 24 and 25 illustrate the driver socket 701. FIG. 24 illustrates a perspective view illustrating the driver socket 701 on which a liquid crystal driver 601 that is an integrated circuit is mounted, and a cross-sectional view taken on line I1-I1 of the perspective view. FIG. 25 is a view illustrating how the liquid crystal driver 601 is mounted on the driver socket 701.

As shown in FIG. 24, the driver socket 701 has driver socket-film (see film 501 in FIG. 23) bumps 702, driver-driver socket bumps 703, and driver socket wires 705.

The driver-driver socket bumps 703 of the driver socket 701 connect (i) the driver socket 701 and (ii) driver bumps 704 provided on the liquid crystal driver 601 (see FIG. 24). The driver-driver socket bumps 703 and the driver bumps 704 have a substantially same bump pitch, which is for example not more than 20 μm.

On the other hand, the driver socket-film bumps 702 of the driver socket 701 connect (i) the driver socket 701 and (ii) wires 502 provided on the film 501 (see FIG. 23). The driver socket-film bumps 702 have a pitch of for example not less than 50 μm, which pitch is wider than the bump pitch of the driver-driver socket bumps 703 and driver bumps 704.

The driver socket 701 on which the liquid crystal driver 601 is mounted, as illustrated in FIG. 24, is mounted on the film 501 illustrated in FIG. 23, by the driver socket-film bumps 702.

In a case where the driver socket 701 is not used, a bump pitch on the film 501 on which mounting is carried out requires to be a pitch of not more than 20 μm, which pitch matches that of the driver bumps 704 of the liquid crystal driver 601, however in a case where the driver socket 701 is used, it is possible to have a pitch of 50 μm, which is the pitch of the driver socket-film bumps 702 on the driver socket 701.

### Citation List

Patent Literature 1

Japanese Patent Application Publication, Tokukai, No. 2004-62146 A (Publication Date: Feb. 26, 2004)

Patent Literature 2

Japanese Patent Application Publication, Tokukai, No. 2005-189804 A (Publication Date: Jul. 14, 2005)

Patent Literature 3

International Publication No. WO 2007/052761 A1 (Publication Date: May 10, 2007)

### SUMMARY OF INVENTION

In the technique disclosed in Patent Literature 1, it is necessary to reduce impedance of wires that supply the storage capacitor driving signals to the storage capacitors, in order to reduce the unevenness in display luminance in the liquid crystal display panel. Further, as a method for reducing the impedance of wires, thickening line width of the wires may be considered.

Here, the wires are provided on a same panel as pixels that carry out a display, that is, on a same glass substrate that carries out the display. The wires provided on the glass substrate have great wire resistance, and in order to reduce the impedance of the wires, the line width of the wires is necessarily sufficiently thick. This causes the liquid crystal display panel to have an extremely thick core wiring, thereby causing an area other than that of display pixels to be large in area. As a result, it is difficult to narrow a frame of the liquid crystal panel.

Moreover, with the technique disclosed in Patent Literature 2, a vibration period of the CS voltage is lengthened to restrain an effect of waveform rounding and reduce the unevenness of the display luminance. In this case, waveform types of the used CS voltage increase in number. As a result, the liquid crystal display panel requires many voltage sources for generating the CS voltage, and together with this, the area other than that of the display pixels become large. As a result, also with the technique disclosed in Patent Literature 2, it is difficult to narrow the frame.

The technique disclosed in Patent Literature 3 is only a technique of suitably mounting an LSI for driving, and is not a technique that presupposes application to a display device driven by multi-picture element driving.

The present invention is accomplished in view of the foregoing problems, and its object is to provide a display device driven by multi-picture element driving, which can realize narrowing of a frame.

In order to attain the object, a display device according to the present invention includes: a scanning line driving device or scanning line driving devices; and a plurality of sub-picture elements, one display picture element being divided into the plurality of sub-picture elements, each of the plurality of sub-picture elements having a storage capacitor that is connected to a respectively different one of storage capacitor wires, the storage capacitors being driven in accordance with storage capacitor driving signals supplied to the storage capacitor wires, to allow display of the plurality of sub-picture elements in such a manner that each of the plurality of sub-picture elements are displayed having a different luminance from each other, the scanning line driving device or scanning line driving devices including: at least one buffer for (i) shaping waveforms of the storage capacitor driving signals to be supplied to the storage capacitor wires, the storage capacitor driving signals being received by the at least one buffer, and (ii) supplying the storage capacitor driving signals thus shaped to the storage capacitor wires.

Here, the process of “shaping waveforms of the storage capacitor driving signals” denotes a process carried out for suitably driving the storage capacitor with the storage capacitor driving signals, such as a process to reduce rounding that occurs to the storage capacitor driving signals. In other words, the process of “shaping waveforms of the storage capacitor driving signals” denotes a process for improving driving ability of the storage capacitor. Generally, a buffer has a Schmitt trigger function, thereby making it easy to carry out such a process.

According to the configuration, the storage capacitor driving signals are once inputted in a buffer that is provided in the scanning line driving device. The buffer shapes waveforms of the received storage capacitor driving signals, and thereafter supplies the signals to the storage capacitor wires. In this way, the storage capacitors are driven in the display device according to the present invention by use of the buffer of the scanning line driving device.

Hence, in the display device according to the present invention, by supplying the storage capacitor driving signals to the storage capacitor wires via the buffer, it is possible to supply to the storage capacitor wires the storage capacitor driving signals reduced in waveform rounding. In other words, as such, driving ability of the storage capacitors is improved in the display device according to the present invention. Thus, the display device according to the present invention can lessen occurrence of waveform rounding, unevenness in display luminance or the like even if a line width of wires that make up a core wiring is reduced in width. Consequently, the display device according to the present invention requires no increase in the number of waveform types of CS voltage, in order that an effect caused by waveform rounding is restrained and unevenness in display luminance is reduced.

With the above arrangement, an area other than that of display pixels is reducible in the display device according to the present invention. Therefore, an effect is attained that a frame can be narrowed in a display device that is driven by multi-picture element driving.

Moreover, the display device according to the present invention is arranged in such a manner that the scanning line driving device further includes wires for outputting the storage capacitor driving signals to be supplied to the storage capacitor wires as supplied, to a destination outside the scanning line driving device, the destination being different from the storage capacitor wires. Moreover, the display device according to the present invention is arranged in such a manner that the scanning line driving devices are connected to each other via the wires.

According to the arrangement, the scanning line driving device further includes wires for outputting the storage capacitor driving signals to a different destination outside the scanning line driving device, which destination is one other than the storage capacitor wires. Therefore, it is effective in the display device according to the present invention to connect a plurality of scanning line driving devices together via the wires. This allows, between the plurality of scanning line driving devices, to input storage capacitor driving signals from one scanning line driving device to another scanning line driving device. Further, in the another scanning line driving device, the storage capacitor driving signals are supplied to the storage capacitor wires via a buffer of the another scanning line driving device, which thereby allows supplying, to the storage capacitor wires, storage capacitor driving signals that are reduced in waveform rounding. That is, it is possible to improve driving ability of the storage capacitor.

Driving the storage capacitors by use of a plurality of scanning line driving devices denotes that the storage capacitors are driven by use of a plurality of buffers. Therefore, in this case, it is possible to further improve the driving ability of the storage capacitors. Consequently, it is possible to even further reduce the line width of the wires which make up the core wiring, in the display device according to the present invention.

Moreover, the display device according to the present invention is arranged in such a manner that the storage capacitor wires are connected to the at least one buffer of a respective one of the scanning line driving devices, and are provided in divisions according to the respective one of the scanning line driving devices.

According to the configuration, the storage capacitor driving signals are separately supplied per scanning line driving device. This allows dividing the core wiring in the display device according to the present invention. As a result, impedance is easily reduced in the core wiring, thereby allowing further reduction in line width of the wires that make up the core wiring.

Moreover, the display device according to the present invention is arranged in such a manner that the at least one buffer included in the scanning line driving device or scanning line driving devices is a plurality of buffers.

According to the arrangement, it is possible to further improve the driving ability of the storage capacitors, by using a plurality of buffers for driving the storage capacitors. This allows further reduction of a line width of the wires that make up the core wiring, in the display device according to the present invention.

Moreover, the display device according to the present invention is arranged in such a manner that the storage capacitor wires are connected to a respective one of the plurality of buffers, and are provided in divisions according to their connected buffer.

According to the arrangement, the storage capacitor driving signals are separately supplied per buffer. This allows dividing the core wiring in the display device according to the present invention. As a result, impedance is easily reduced in the core wiring, thereby allowing further reduction in line width of wires that make up the core wiring.

Moreover, the display device according to the present invention is arranged in such a manner that the at least one buffer of the scanning line driving device or scanning line driving devices supplies the received storage capacitor driving signals to the storage capacitor wires by overshoot driving.

According to the arrangement, the buffer of the scanning line driving device supplies the storage capacitor driving signals to the storage capacitor wires by overshoot driving. This shortens a required time to charge the storage capacitors connected to the storage capacitor wires, thereby allowing rapid driving of the plurality of sub-picture elements. Further, with this arrangement, it is possible to reduce unevenness in display luminance and unevenness in display, even in a case where driving time is shortened caused by the increase in number of the scanning lines, in the display device according to the present invention.

In order to attain the foregoing object, a display device according to the present invention includes: a scanning line driving device or scanning line driving devices; and a plurality of sub-picture elements, one display picture element being divided into the plurality of sub-picture elements, each of the sub-picture elements having a storage capacitor that is connected to a respectively different one of storage capacitor wires, the storage capacitors being driven in accordance with storage capacitor driving signals supplied to the storage capacitor wires, to allow display of the plurality of sub-picture elements in such a manner that the plurality of sub-picture elements are displayed having a different luminance from each other, the scanning line driving device including: a first buffer for (i) shaping waveforms of the storage capacitor driving signals to be supplied to the storage capacitor wires, the storage capacitor driving signals being received by the first buffer, and (ii) supplying the storage capacitor driving signals thus shaped to the storage capacitor wires; and a second buffer for (i) shaping waveforms of the storage capacitor driving signals to be supplied to the storage capacitor wires, the storage capacitor driving signals being received by the second buffer, and (ii) outputting the storage capacitor driving signals thus shaped to a destination outside the scanning line driving device, the destination being different from the storage capacitor wires.

According to the arrangement, the storage capacitor driving signals are once inputted in a first buffer that is provided in the scanning line driving device. The first buffer shapes waveforms of the received storage capacitor driving signals, and thereafter supplies the signals to the storage capacitor wires. In this way, the storage capacitors are driven in the display device according to the present invention by use of the first buffer of the scanning line driving device.

Here, in the display device according to the present invention, the storage capacitor driving signals are further once inputted in a second buffer that is provided in the scanning line driving device separately to the first buffer. The second buffer shapes the waveforms of the received storage capacitor driving signals, and outputs the signals to a destination different from the storage capacitor wires.

Hence, in the display device according to the present invention, by supplying the storage capacitor driving signals to the storage capacitor wires via the first buffer, it is possible to supply to the storage capacitor wires the storage capacitor driving signals reduced in waveform rounding. In other words, as such, the driving ability of the storage capacitors is improved in the display device according to the present invention. Thus, the display device according to the present invention can lessen the occurrence of waveform rounding, unevenness in display luminance or the like even if a line width of the wires that make up the core wiring is reduced in width. Consequently, the display device according to the present invention requires no increase in the number of waveform types of CS voltage in order that an effect caused by waveform rounding is restrained and unevenness in display luminance is reduced.

With the above arrangement, an area other than that of display pixels is reducible in the display device according to the present invention.

Therefore, an effect is attained that a frame can be narrowed in a display device that is driven by multi-picture element driving.

Moreover, according to the arrangement, the storage capacitor driving signals that are reduced in waveform rounding can be inputted to a device outside the scanning signal driving device, by outputting the storage capacitor driving signals inputted in the second buffer of the scanning line driving device to a destination outside the scanning signal driving device.

Moreover, the display device according to the present invention is arranged in such a manner that the scanning line driving devices are provided in series, to have a plurality of stages, the second buffer of each of the scanning line driving devices that are provided previously to a scanning line driving device of a last stage being connected to the first buffer of a corresponding scanning line driving device that is provided in a subsequent stage of said each of the scanning line driving devices.

According to the arrangement, in the scanning line driving device according to the present invention, the second buffer of each of the scanning line driving devices that are provided in a stage previously to a scanning line driving device of a last stage are connected to the first buffer of corresponding scanning line driving devices provided in their subsequent stages. In the display device according to the present invention, it is effective to successively connect the scanning line driving devices together as such. This allows successively inputting to the scanning line driving devices the storage capacitor driving signals reduced in waveform rounding, between the scanning line driving devices. Further, in each of the scanning line driving devices, by supplying the storage capacitor driving signals to the storage capacitor wires via the first buffer of corresponding subsequent scanning line driving devices, it is possible to supply the storage capacitor driving signals that are reduced in waveform rounding to the storage capacitor wires. That is to say, it is possible to improve driving ability of the storage capacitors.

Driving the storage capacitors by the plurality of stages of the scanning line driving device means that the storage capacitors are driven by use of a plurality of the first buffers. Therefore, in this case, it is possible to further improve the driving ability of the storage capacitors. Accordingly, it is possible to even further reduce the line width of the wires which make up the core wiring, in the display device according to the present invention.

Moreover, according to the arrangement, the storage capacitor driving signals are outputted to the subsequent scanning line driving device via the second buffer of the scanning line driving device. Thus, it is possible to prevent varying of waveforms of the storage capacitor driving signals between the plurality of scanning line driving devices, caused by rounding and delay of the storage capacitor driving signals.

Moreover, the display device according to the present invention is arranged in such a manner that the first buffer of the scanning line driving device supplies the received storage capacitor driving signals to the storage capacity wires by overshoot driving.

According to the arrangement, the first buffer of the scanning line driving device supplies the storage capacitor driving signals to the storage capacitor wires by overshoot driving. This shortens a time required to charge the storage capacitors connected to the storage capacitor wires, thereby allowing rapid driving of a plurality of sub-picture elements. Furthermore, with this arrangement, it is possible to reduce unevenness in display luminance and unevenness in display, even in a case where driving time is shortened caused by the increase in the number of the scanning lines, in the display device according to the present invention.

Moreover, the display device according to the present invention may be arranged in such a manner that the storage capacitor driving signals to be supplied to the storage capacity wires are inputted in the scanning line driving device.

In order to attain the object, a scanning line driving device according to the present invention is a scanning line driving device provided in a display device for driving scanning lines that are provided in the display device, the display device including a plurality of sub-picture elements, one display picture element being divided into the plurality of sub-picture elements, each of the plurality of sub-picture elements having a storage capacitor that is connected to a respectively different one of storage capacitor wires, the storage capacitors being driven in accordance with storage capacitor driving signals supplied to the storage capacitor wires, to allow display of the plurality of sub-picture elements in such a manner that each of the plurality of sub-picture elements are displayed having a different luminance from each other, the scanning line driving device including: a buffer for (i) shaping waveforms of the storage capacitor driving signals to be supplied to the storage capacitor wires, the storage capacitor driving signals being received by the buffer, and (ii) supplying the storage capacitor driving signals thus shaped to the storage capacitor wires.

According to the arrangement, the storage capacitor driving signals are once inputted into a buffer provided in the scanning line driving device. The buffer shapes the waveforms of the inputted storage capacitor driving signals, and thereafter supplies the signals to the storage capacitor wires of the display device. The scanning line driving device according to the present invention drives the storage capacitors by use of the buffer, as such.

Hence, in the scanning line driving device according to the present invention, by supplying the storage capacitor driving signals to the storage capacitor wires of the display device via the buffer, it is possible to supply to the storage capacitor wires of the display device the storage capacitor driving signals reduced in waveform rounding. In other words, as such, driving ability of the storage capacitor is improved in the display device. Thus, the scanning line driving device according to the present invention allows restraining the effect caused by occurrence of waveform rounding, unevenness in display luminance or the like even if a line width of the wires that make up a core wiring in the display device is reduced in width. Hence, a display device that includes the scanning line driving device according to the present invention requires no increase in the number of waveform types of CS voltage in order that an effect caused by waveform rounding is restrained and unevenness in the display luminance is reduced.

With the above arrangement, the scanning line driving device according to the present invention allows reduction of an area other than that of display pixels in a display device driven by multi-picture element driving. Therefore, an effect is attained that a frame can be narrowed in a display device that is driven by multi-picture element driving.

Moreover, the scanning line driving device according to the present invention further includes wires for outputting the storage capacitor driving signals to be supplied to the storage capacitor wires as supplied, to a destination outside the scanning line driving device, the destination being different from the storage capacitor wires.

According to the arrangement, the scanning line driving device further includes wires for outputting the inputted storage capacitor driving signals as supplied to a destination outside the scanning line driving device, which destination is one other than the storage capacitor wires. Therefore, it is possible to have an external device input the storage capacitor driving signals by connecting with the scanning line driving device according to the present invention via the wires.

Moreover, the scanning line driving device according to the present invention is arranged in such a manner that the buffer supplies the received storage capacitor driving signals to the storage capacitor wires by overshoot driving.

According to the arrangement, the buffer supplies the storage capacitor driving signals to the storage capacitor wires by overshoot driving. This shortens a required time to charge the storage capacitor connected to the storage capacitor wires, thereby allowing rapid driving of the plurality of sub-picture elements. Further, with this arrangement, it is possible to reduce unevenness in display luminance and unevenness in display, even in a case where driving time is shortened caused by the increase in the number of the scanning lines, in a display device including the scanning line driving device according to the present invention.

In order to attain the object, a scanning line driving device according to the present invention is a scanning line driving device provided in a display device for driving scanning lines that are provided in the display device, the display device including a plurality of sub-picture elements, one display picture element being divided into the plurality of sub-picture elements, each of the plurality of sub-picture elements having a storage capacitor that is connected to a respectively different one of storage capacitor wires, the storage capacitors being driven in accordance with storage capacitor driving signals supplied to the storage capacitor wires, to allow display of the plurality of sub-picture elements in such a manner that each of the plurality of sub-picture elements are displayed having a different luminance from each other, the scanning line driving device including: a first buffer for (i) shaping waveforms of the storage capacitor driving signals to be supplied to the storage capacitor wires, the storage capacitor driving signals being received by the first buffer, and (ii) supplying the storage capacitor driving signals thus shaped to the storage capacitor wires; and a second buffer for (i) shaping waveforms of the storage capacitor driving signals to be supplied to the storage capacitor wires, the storage capacitor driving signals being received by the second buffer, and (ii) outputting the storage capacitor driving signals thus shaped to a destination outside the scanning line driving device, the destination being different from the storage capacitor wires.

According to the arrangement, the storage capacitor driving signals are once inputted into a first buffer provided in the scanning line driving device. The first buffer shapes the waveforms of the inputted storage capacitor driving signals, and thereafter supplies the signals to the storage capacitor wires. The scanning line driving device according to the present invention drives the storage capacitors by use of the first buffer provided therein, as such.

Here, in the scanning line driving device according to the present invention, the storage capacitor driving signals are further once inputted in a second buffer provided separately to the first buffer. The second buffer shapes the waveforms of the inputted storage capacitor driving signals, and thereafter outputs the signals to a destination outside the scanning line driving device, which destination is one that is different from the storage capacitor wires.

Hence, in the scanning line driving device according to the present invention, by supplying the storage capacitor driving signals to the storage capacitor wires of the display device via the first buffer, it is possible to supply to the storage capacitor wires of the display device the storage capacitor driving signals reduced in waveform rounding. In other words, as such, driving ability of the storage capacitor provided in the display device is improved. Thus, with the scanning line driving device according to the present invention, it is possible to restrain the effect caused by occurrence of waveform rounding, unevenness in display luminance or the like, even in a case where the line width of the wires which make up the core wiring provided in the display device are reduced in width. Consequently, the display device including the scanning line driving device according to the present invention requires no increase in the number of waveform types of the CS voltage in order that an effect caused by waveform rounding is restrained and unevenness in the display luminance is reduced.

With the above arrangement, an area other than that of the display pixels is reducible in the scanning line driving device according to the present invention in a display device that is driven by multi-picture element driving.

Therefore, an effect is attained that a frame can be narrowed in a display device that is driven by multi-picture element driving.

Moreover, according to the arrangement, the storage capacitor driving signals that are reduced in waveform rounding can be inputted to a device outside of the scanning line driving device, by outputting the storage capacitor driving signals received in the second buffer of the scanning line driving device to a destination outside of the scanning line driving device.

Moreover, the scanning line driving device according to the present invention is arranged in such a manner that the first buffer supplies the received storage capacitor driving signals to the storage capacitor wires by overshoot driving.

According to the arrangement, the first buffer supplies the storage capacitor driving signals to the storage capacitor wires by overshoot driving. This shortens a required time to charge the storage capacitor connected to the storage capacitor wires, thereby allowing rapid driving of the plurality of sub-picture elements. Further, with this arrangement, it is possible to reduce unevenness in display luminance and unevenness in display, even in a case where driving time is shortened caused by the increase in the number of the scanning lines, in the display device including the scanning line driving device according to the present invention.

Moreover, the scanning line driving device according to the present invention may be arranged in such a manner that the storage capacitor driving signals to be supplied to the storage capacitor wires are inputted in the scanning line driving device.

In order to attain the object, a display device according to the present invention includes: a scanning wiring made up of a plurality of scanning lines; and a scanning line driving device for driving the plurality of scanning lines in accordance with scanning line driving signals that are supplied to each of the plurality of scanning lines, one display picture element being divided into a plurality of sub-picture elements, each of the plurality of sub-picture elements having a storage capacitor that is connected to a respectively different one of storage capacitor wires, the storage capacitor connected to the storage capacity wires being driven in accordance with storage capacitor driving signals supplied to the storage capacitor wires, to allow display of the plurality of sub-picture elements in such a manner that each of the plurality of sub-picture elements are displayed having a different luminance from each other, the scanning line driving device including: a plurality of first terminals for supplying to the storage capacitor wires the storage capacitor driving signals to be supplied to the storage capacitor wires; and a plurality of second terminals for supplying to the scanning lines scanning line driving signals to be supplied to the scanning lines, any one or two or more of the plurality of first terminals being provided between any two terminals of the plurality of second terminals.

According to the arrangement, in a display device according to the present invention, the storage capacitor driving signals are supplied from first terminals provided in the scanning line driving device to the storage capacitor wires. Hence, it is possible to drive the storage capacitor provided in the storage capacitor wires by the scanning line driving device.

Here, the scanning line driving device has a plurality of first terminals. Therefore, in the scanning line driving device, storage capacitor wires are respectively connected the plurality of first terminals, thereby allowing supplying of the storage capacitor driving signals to the plurality of the storage capacitor wires. In a case of a display device driven by multi-picture element driving, one display picture element is divided into a plurality of sub-picture elements, and each of the plurality of sub-picture elements has a respectively different storage capacitor wire. By providing the first terminals to the scanning line driving device by the number of the storage capacitor wires, and respectively connecting the storage capacitor wires and the first terminals, it is possible to supply to each of the storage capacitor wires the storage capacitor driving signals, with use of the scanning line driving device. Moreover, in a case where the plurality of first terminals are provided in the scanning line driving device, there is no need to provide a core wiring for supplying the storage capacitor driving signals to the storage capacitor wires outside the scanning line driving device. Therefore, it is possible to avoid difficulty of narrowing the frame that is caused by (i) thickening of the wires that make up the core wiring or (ii) increasing the number of waveform types of the CS voltage in order that the effect caused by waveform rounding is restrained and unevenness of display luminance is reduced in the wires.

Moreover, in the scanning line driving device, at least one terminal of any of the plurality of first terminals is provided between any two terminals of the plurality of second terminals provided for supplying scanning line driving signals to each of the plurality of scanning lines. Namely, in the scanning line driving device, the first terminals are provided between the plurality of the second terminals. Hence, in the scanning line driving device, the storage capacitor driving signals are also easily supplied to the storage capacitor wire provided near the second terminals. That is to say, in the display device according to the present invention, the storage capacitor driving signals are easily supplied to the storage capacitor wires by use of the scanning line driving device.

With the above arrangement, an area other than that of the display pixels is reducible in the display device according to the present invention. Therefore, an effect is attained that a frame can be narrowed in the display device driven by multi-picture element driving.

Moreover, the display device according to the present invention is arranged in such a manner that the scanning line driving device further includes third terminals via which the storage capacitor driving signals to be supplied to the storage capacitor wires are inputted from outside the scanning line driving device, the third terminals being connected to the plurality of first terminals, respectively.

This arrangement allows inputting the storage capacitor driving signals from third terminals to the scanning line driving device, then supplying the signals to the storage capacitor wires via the first terminals.

Moreover, a display device according to the present invention may be arranged such that the scanning line driving device includes: a substrate having the plurality of first terminals, the plurality of second terminals, and third terminals via which the storage capacitor driving signals to be supplied to the storage capacitor wires are inputted from outside the scanning line driving device; and an integrated circuit for generating the scanning line driving signals and supplying the generated scanning line driving signals to the plurality of second terminals.

Moreover, the display device according to the present invention further includes a buffer provided between the third terminals and the plurality of first terminals, for (i) shaping waveforms of the storage capacitor driving signals to be supplied to the storage capacitor wires via the third terminals and (ii) outputting the storage capacitor driving signals thus shaped to the plurality of first terminals. Moreover, the display device according to the present invention is arranged in such a manner that the integrated circuit includes a buffer for (i) shaping waveforms of the storage capacitor driving signals to be supplied to the storage capacitor wires, the storage capacitor driving signals being received by the buffer, and (ii) outputting the storage capacitor driving signals, the buffer having an input terminal connected to the third terminals and an output terminal connected to the plurality of first terminals. Moreover, the display device according to the present invention is arranged in such a manner that the substrate includes a buffer for (i) shaping waveforms of the storage capacitor driving signals to be supplied to the storage capacitor wires, the storage capacitor driving signals being received by the buffer, and (ii) outputting the storage capacitor driving signals thus shaped, the buffer having an input terminal connected to the third terminals, and an output terminal connected to the plurality of first terminals.

According to the arrangement, the storage capacitor driving signals inputted in the scanning line driving device from the third terminals are inputted to the buffer. The buffer shapes the waveforms of the inputted storage capacitor driving signals, and thereafter supplies the signals to the storage capacitor wires via the first terminals.

Here, the process of “shaping waveforms of the storage capacitor driving signals” denotes a process carried out for suitably driving the storage capacitor with the storage capacitor driving signals, such as a process to reduce rounding that occurs to the storage capacitor driving signals. In other words, the process of “shaping waveforms of the storage capacitor driving signals” denotes a process for improving driving ability of the storage capacitor. Generally, a buffer has a Schmitt trigger function. Such a buffer having the Schmitt trigger function can easily carry out such a process.

Hence, in the display device according to the present invention, by supplying storage capacitor driving signals to the storage capacitor wires via the buffer, it is possible to supply to the storage capacitor wires the storage capacitor driving signals reduced in waveform rounding. In other words, as such, driving ability of the storage capacitors is improved in the display device according to the present invention. Thus, the display device according to the present invention can restrain the effect caused by occurrence of waveform rounding, unevenness in display luminance or the like, even in a case where the line width of the storage capacitor wires are reduced in width.

With the above arrangement, an area other than that of display pixels is reducible in the display device according to the present invention. Therefore, an effect is attained that a frame can be narrowed in a display device that is driven by multi-picture element driving.

Moreover, the display device according to the present invention is arranged in such a manner that the buffer outputs the received storage capacitor driving signals by overshoot driving.

According to the arrangement, the buffer outputs the storage capacitor driving signals by overshoot driving. This shortens a time required to charge the storage capacitors to which the storage capacitor driving signals are supplied, which storage capacitors are connected to the storage capacitor wires, thereby allowing rapid driving of the plurality of sub-picture elements. Furthermore, it is possible to reduce unevenness in display luminance and unevenness in display even in a case where a driving time is shortened due to an increase in number of the scanning lines, in the display device according to the present invention.

As described above, a display device according to the present invention includes: a scanning line driving device or scanning line driving devices; and a plurality of sub-picture elements, one display picture element being divided into the plurality of sub-picture elements, each of the plurality of sub-picture elements having a storage capacitor that is connected to a respectively different one of storage capacitor wires, the storage capacitors being driven in accordance with storage capacitor driving signals supplied to the storage capacitor wires, to allow display of the plurality of sub-picture elements in such a manner that each of the plurality of sub-picture elements are displayed having a different luminance from each other, the scanning line driving device or scanning line driving devices including: at least one buffer for (i) shaping waveforms of the storage capacitor driving signals to be supplied to the storage capacitor wires, the storage capacitor driving signals being received by the at least one buffer, and (ii) supplying the storage capacitor driving signals thus shaped to the storage capacitor wires.

Moreover, a display device according to the present invention includes: a scanning line driving device or scanning line driving devices; and a plurality of sub-picture elements, one display picture element being divided into the plurality of sub-picture elements, each of the sub-picture elements having a storage capacitor that is connected to a respectively different one of storage capacitor wires, the storage capacitor being driven in accordance with storage capacitor driving signals supplied to the storage capacitor wires, to allow display of the plurality of sub-picture elements in such a manner that the plurality of sub-picture elements are displayed having a different luminance from each other, the scanning line driving device including: a first buffer for (i) shaping waveforms of the storage capacitor driving signals to be supplied to the storage capacitor wires, the storage capacitor driving signals being received by the first buffer, and (ii) supplying the storage capacitor driving signals thus shaped to the storage capacitor wires; and a second buffer for (i) shaping waveforms of the storage capacitor driving signals to be supplied to the storage capacitor wires, the storage capacitor driving signals being received by the second buffer, and (ii) outputting the storage capacitor driving signals thus shaped to a destination outside the scanning line driving device, the destination being different from the storage capacitor wires.

As described above, a scanning line driving device according to the present invention is a scanning line driving device provided in a display device for driving scanning lines that are provided in the display device, the display device including a plurality of sub-picture elements, one display picture element being divided into the plurality of sub-picture elements, each of the plurality of sub-picture elements having a storage capacitor that is connected to a respectively different one of storage capacitor wires, the storage capacitors being driven in accordance with storage capacitor driving signals supplied to the storage capacitor wires, to allow display of the plurality of sub-picture elements in such a manner that each of the plurality of sub-picture elements are displayed having a different luminance from each other, the scanning line driving device including: a buffer for (i) shaping waveforms of the storage capacitor driving signals to be supplied to the storage capacitor wires, the storage capacitor driving signals being received by the buffer, and (ii) supplying the storage capacitor driving signals thus shaped to the storage capacitor wires.

Moreover, a scanning line driving device according to the present invention is a scanning line driving device provided in a display device for driving scanning lines that are provided in the display device, the display device including a plurality of sub-picture elements, one display picture element being divided into the plurality of sub-picture elements, each of the plurality of sub-picture elements having a storage capacitor that is connected to a respectively different one of storage capacitor wires, the storage capacitors being driven in accordance with storage capacitor driving signals supplied to the storage capacitor wires, to allow display of the plurality of sub-picture elements in such a manner that each of the plurality of sub-picture elements are displayed having a different luminance from each other, the scanning line driving device including: a first buffer for (i) shaping waveforms of the storage capacitor driving signals to be supplied to the storage capacitor wires, the storage capacitor driving signals being received by the first buffer, and (ii) supplying the storage capacitor driving signals thus shaped to the storage capacitor wires; and a second buffer for (i) shaping waveforms of the storage capacitor driving signals to be supplied to the storage capacitor wires, the storage capacitor driving signals being received by the second buffer, and (ii) outputting the storage capacitor driving signals thus shaped to a destination outside the scanning line driving device, the destination being different from the storage capacitor wires.

As described above, a display device includes a scanning wiring made up of a plurality of scanning lines; and a scanning line driving device for driving the plurality of scanning lines in accordance with scanning line driving signals that are supplied to each of the plurality of scanning lines, one display picture element being divided into a plurality of sub-picture elements, each of the plurality of sub-picture elements having a storage capacitor that is connected to a respectively different one of storage capacitor wires, the storage capacitor connected to the storage capacity wires being driven in accordance with storage capacitor driving signals supplied to the storage capacitor wires, to allow display of the plurality of sub-picture elements in such a manner that each of the plurality of sub-picture elements are displayed having a different luminance from each other, the scanning line driving device including: a plurality of first terminals for supplying to the storage capacitor wires the storage capacitor driving signals to be supplied to the storage capacitor wires; and a plurality of second terminals for supplying to the scanning lines scanning line driving signals to be supplied to the scanning lines, any one or two or more of the plurality of first terminals being provided between any two terminals of the plurality of second terminals.

Therefore, an effect is attained that a frame can be narrowed in a display device that is driven by multi-picture element driving.

### BRIEF DESCRIPTION OF DRAWINGS

FIG. 1 illustrates one embodiment of the present invention, and is a block diagram schematically illustrating a scanning line driving device.

FIG. 2 is a view illustrating a circuit configuration of a buffer according to the present invention.

FIG. 3 is a view illustrating an external form of the scanning line driving device of FIG. 1.

FIG. 4 is a view illustrating a display device according to the present invention, and is a view showing how the scanning line driving device of FIG. 1 is mounted to a substrate of the display device.

FIG. 5 illustrates another embodiment of the present invention, and is a block diagram schematically illustrating a scanning line driving device.

FIG. 6 is a view illustrating a circuit configuration of another buffer according to the present invention.

FIG. 7 is a graph illustrating a waveform of a storage capacitor driving signal which has been subjected to an overshooting process by the buffer in FIG. 6.

FIG. 8 is a graph illustrating an external form of the scanning line driving device of FIG. 5.

FIG. 9 illustrates yet another embodiment of the present invention, and is a block diagram schematically illustrating a scanning line driving device.

FIG. 10 is a view illustrating an external form of the scanning line driving device of FIG. 9.

FIG. 11 is a graph illustrating gamma characteristics of a liquid crystal display panel in a liquid crystal display device.

FIG. 12 is a view illustrating a configuration example of a display picture element of a liquid crystal display device that is driven by multi-picture element driving.

FIG. 13 is a view illustrating one example of each of waveforms of a source voltage and a storage capacitor counter voltage that are applied to respective sub-picture elements, in the liquid crystal display device of FIG. 12.

FIG. 14 is a graph illustrating an example of inverting waveforms of the storage capacitor counter voltage per two frames.

FIG. 15 is a view schematically illustrating an equivalent circuit of the liquid crystal display device.

FIG. 16 is a view illustrating wiring of storage capacitor driving signals in a glass substrate of a liquid crystal display panel.

FIG. 17 is a view illustrating another display device according to the present invention, and is a view illustrating how the scanning line driving device illustrated in FIG. 5 is mounted to a substrate of a display device.

FIG. 18 is a view illustrating yet another display device according to the present invention, and is a view illustrating how the scanning line driving device illustrated in FIG. 9 is mounted to a substrate of a display device.

FIG. 19 is a block diagram schematically illustrating yet another configuration of a scanning line driving device provided in a display device according to the present invention.

FIG. 20 is a view illustrating an outline of a scanning line driving device package in which the scanning line driving device of FIG. 19 is incorporated.

FIG. 21 is a view illustrating an overview of a scanning line driving device; (a) of FIG. 21 is a perspective view illustrating a state in which an integrated circuit is mounted on a substrate, (b) of FIG. 21 is a view illustrating how an integrated circuit having the buffer is mounted to the substrate, and (c) of FIG. 21 is a view illustrating how an integrated circuit is mounted on a substrate having the buffer.

FIG. 22 is a view illustrating a display device according to the present invention, and is a view illustrating a state in which the scanning line driving device package of FIG. 20 is mounted to a substrate of the display device.

In FIG. 23, (a) is a top view of an IC chip mounting package according to a conventional technique, and (b) of FIG. 23 is its cross-sectional view taken on line G-G.

In FIG. 24, (a) is a perspective view illustrating a state in which a liquid crystal driver that is an integrated circuit is mounted on a driver socket, and (b) of FIG. 24 is its cross-sectional view taken on line I1-I1.

FIG. 25 is a view illustrating the driver socket, and is a view illustrating how the liquid crystal driver is mounted on the driver socket.

### DESCRIPTION OF EMBODIMENTS

### Embodiment 1

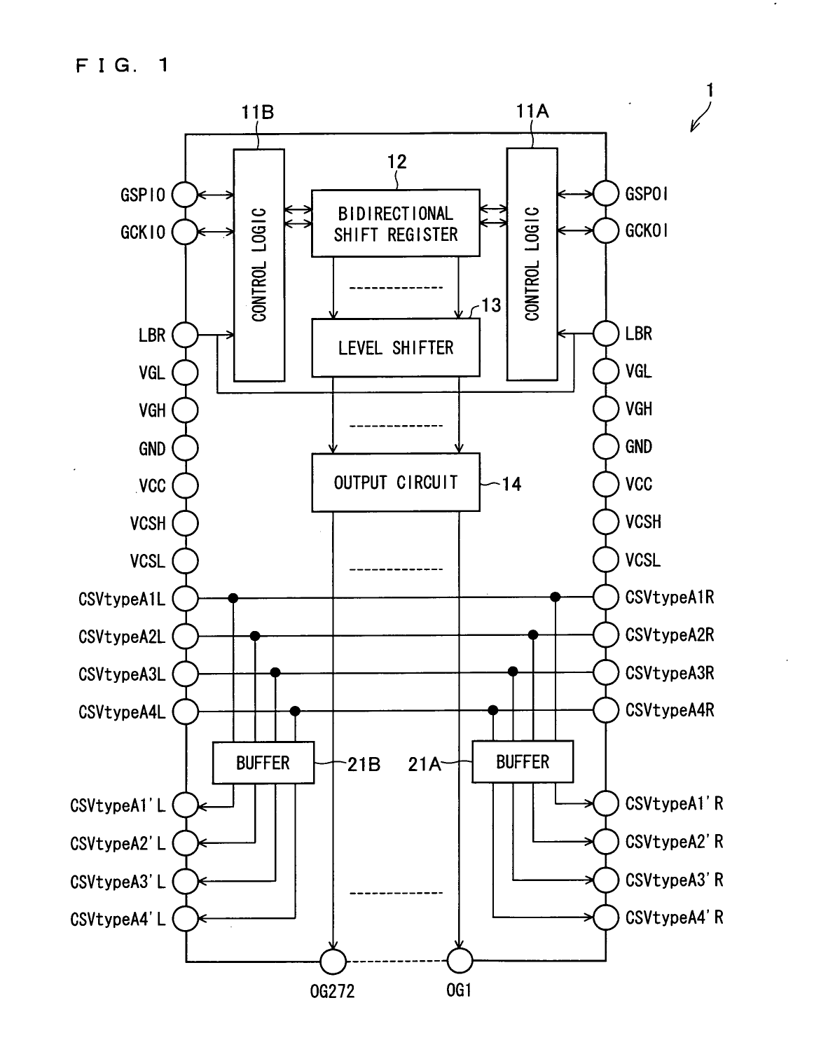

FIG. 1 illustrates one embodiment of the present invention, and is a block diagram schematically illustrating a configuration of a scanning line driving device.

A gate driver (scanning line driving device) 1 illustrated in FIG. 1 includes control logics 11A and 11B, a bidirectional shift register 12, a level shifter 13, and an output circuit 14. Furthermore, the gate driver 1 includes buffers 21A and 21B.

The round members that are illustrated in FIG. 1 are all terminals provided in the gate driver 1, and the signs (letters) that are given to the round members are terminal names of the terminals.

Terminals “LBR” provided in the gate driver 1 are input terminals in which control signals indicating a shifting direction of the bidirectional shift register 12 are inputted. The terminals “LBR” have a state “H” and a state “L”. The gate driver 1 controls a shifting direction of the bidirectional shift register 12 by causing the terminals “LBR” to switch between the state “H” and the state “L” in accordance with the control signals. This control determines a scanning direction of scanning line driving signals outputted by the output circuit 14.

Terminal “GSPOI” and terminal “GSPIO” provided in the gate driver 1 are IO (Input/Output) terminals having a function to switch between an input terminal and an output terminal, in accordance with the control signals inputted to the terminals “LBR”.

When the terminals “LBR” are in the state “H”, the terminal “GSPOI” is an input terminal and the terminal “GSPIO” is an output terminal. When the terminals “LBR” are in the state “L”, the terminal “GSPOI” is an output terminal and the terminal “GSPIO” is an input terminal.

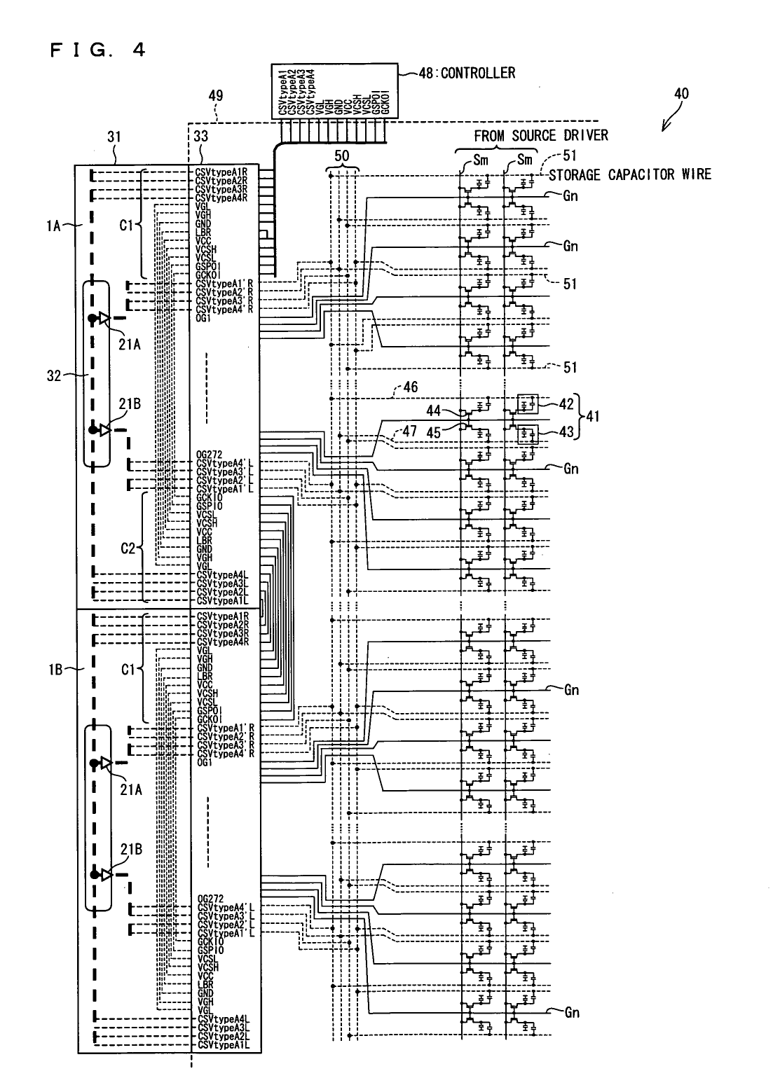

Of the terminal “GSPOI” and terminal “GSPIO”, the terminal having an input terminal function receives input of signals for starting operation of the bidirectional shift register (hereinafter referred to as “scanning start signals”). Moreover, of the terminal “GSPOI” and terminal “GSPIO”, the terminal having an output terminal function outputs the scanning start signals to a subsequent gate driver (not illustrated) that is cascade-connected to the gate driver 1. In the embodiment, for example if the gate driver 1 is a gate driver 1A illustrated in FIG. 4 later described, the “subsequent gate driver” is a gate driver 1B illustrated in FIG. 4.

Terminal “GCKOI” and terminal “GCKIO” provided in the gate driver 1 are, as similar to the terminal “GSPOI” and terminal “GSPIO”, IO terminals that have a function to switch between an input terminal and an output terminal, depending on the control signals inputted to the terminals “LBR”.

When the terminals “LBR” are in the state “H”, the terminal “GCKOI” is an input terminal and the terminal “GCKIO” is an output terminal. When the terminals “LBR” are in the state “L”, the terminal “GCKOI” is an output terminal and the terminal “GCKIO” is an input terminal.

Of the terminal “GCKOI” and terminal “GCKIO”, the terminal having the input terminal function receives an input of driving clock signals of the bidirectional shift register 12. Moreover, of the terminal “GCKOI” and terminal “GCKIO”, the terminal having the output terminal function outputs the driving clock signals to the subsequent gate driver.

Terminals “VGL” and terminals “VGH” provided in the gate driver 1 are power supply terminals that are connected to a power supply not illustrated, for operating the output circuit 14. The output circuit 14 outputs scanning line driving signals to terminals “OG1” to “OG272” later described. The output circuit 14 outputs the scanning line driving signals as signals having an amplitude from vgl to vgh, provided that a power supply voltage applied to the terminals “VGL” is vgl and a power supply voltage applied to the terminals “VGH” is vgh.

Terminals “VCC” provided in the gate driver 1 are power supply terminals connected to a power supply not illustrated, for operating the gate driver 1. Terminals “GND” provided in the gate driver 1 are ground terminals.

Moreover, the gate driver 1 has 272 terminals, of terminal “OG1” to terminal “OG272”. For convenience, in the drawings of the present application, the terminals of the terminals “OG1” to “OG272” have been partially omitted in illustration. The terminals “OG1” to “OG272” are external output terminals for outputting the scanning line driving signals from the output circuit 14 externally of the gate driver 1.

The terminals “OG1” to “OG272” are scanning line driving terminals of the gate driver 1 which are connected to the scanning lines Gn (see FIG. 4), which terminals provide scanning line driving signals to the scanning lines Gn for driving the scanning lines Gn. The gate driver 1 illustrated in FIG. 1 has 272 terminals, the terminals “OG1” to “OG272”. Hence, it is possible to drive a maximum of 272 scanning lines.

Terminals “CSVtypeA1R” to “CSVtypeA4R” and terminals “CSVtypeA1L” to “CSVtypeA4L” that are provided in the gate driver 1 are input terminals of storage capacitor driving signals, for inputting the storage capacitor driving signals to the buffers 21A and 21B.

Terminals “CSVtypeA1′R” to “CSVtypeA4′R” that are provided in the gate driver 1 are output terminals of the storage capacitor driving signals, for outputting the storage capacitor driving signals that are outputted from the buffer 21A, and terminals “CSVtypeA1′L” to “CSVtypeA4′L” provided in the gate driver 1 are output terminals for outputting the storage capacitor driving signals that are outputted from the buffer 21B, which storage capacitor driving signals are outputted to respective storage capacitor wires (for example, see storage capacitor wires 51 in FIG. 4).

The terminal “CSVtypeA1R” is connected to the terminal “CSVtypeA1L”. The terminal “CSVtypeA2R” is connected to the terminal “CSVtypeA2L”. The terminal “CSVtypeA3R” is connected to the terminal “CSVtypeA3L”. The terminal “CSVtypeA4R” is connected to the terminal “CSVtypeA4L”.

Connected parts of terminals “CSVtypeA1R” to “CSVtypeA4R” and corresponding terminals “CSVtypeA1L” to “CSVtypeA4L” are connected to one of ends (input terminal) of the buffer 21A and one of ends (input terminal) of the buffer 21B. The other one of the ends of the buffer 21A (output terminal) is connected to the terminals “CSVtypeA1′R” to “CSVtypeA4′R”, and the other one of the ends of the buffer 21B (output terminal) is connected to the terminals “CSVtypeA1′L” to “CSVtypeA4′L”.

The storage capacitor driving signals inputted in the gate driver 1 are inputted to the buffers 21A and 21B via the connected parts of the terminals “CSVtypeA1R” to “CSVtypeA4R” and the corresponding terminals “CSVtypeA1L” to “CSVtypeA4L”. The buffer 21A and 21B shapes the waveforms of the inputted storage capacitor driving signals, and outputs them to the terminals “CSVtypeA1′R” to “CSVtypeA4′R” and terminals “CSVtypeA1′L” to “CSVtypeA4′L”. The gate driver 1 provides, to the storage capacitor wires, storage capacitor driving signals reduced in waveform rounding, by causing the storage capacitor driving signals to pass through the buffers 21A and 21B, and drives storage capacitors (see FIG. 4) connected to corresponding storage capacitor wires.

The buffer used in the display device and scanning line driving device according to the present invention is suitably used for, for example, adjusting the number of fan in of input, and improving driving ability of output. Generally, many of the buffer that are used for input has the Schmitt trigger function, and thus is possible to remove noise from an input signal and shape the waveform.

A process to “shape waveforms of storage capacitor driving signals” denotes processes for suitably driving the storage capacitor with use of the storage capacitor driving signals, such as a process for causing reduction of rounding generated in the storage capacitor driving signals, and a process for causing amplification of an amplitude of the storage capacitor driving signals, that is, general processes for improving driving ability of the storage capacitor driving signals. Generally, due to the Schmit trigger function, it is relatively easy to carry out such processes with the buffer.

Terminals “VCSH” and terminals “VCSL” provided in the gate driver 1 are power supply terminals to which a power supply not illustrated is connected, for operating a buffer provided to the scanning line driving device according to the present invention. That is to say, the terminals “VCSH” and terminals “VCSL” in the gate driver 1 can be interpreted as power supply terminals to which a power supply not illustrated is connected, for operating the buffers 21A and 21B. A power supply voltage applied to the terminals “VCSH” is higher than a power supply voltage applied to the terminals “VCSL”.

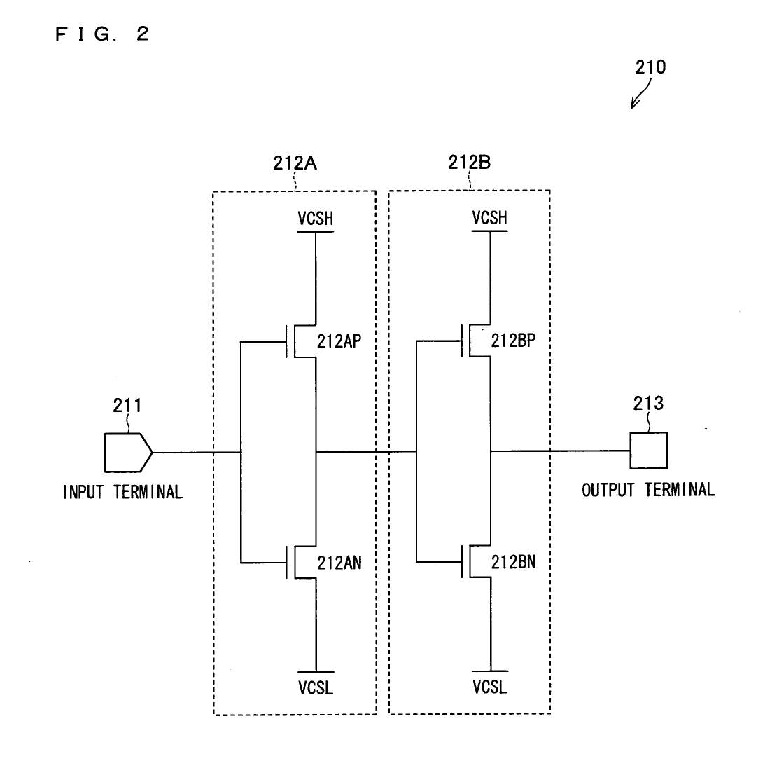

FIG. 2 illustrates a circuit configuration of the buffer.

A buffer 210 illustrated in FIG. 2 is suitably used as each of the buffers (buffers 21A, 21B, 22, and 23) according to the present embodiment. The buffer 210 illustrated in FIG. 2 includes an input terminal 211, two inverters 212A and 212B, and an output terminal 213, which are connected in this order.

The buffer 210 illustrated in FIG. 2 has the input terminal 211 connected between the terminal “CSVtypeA1R” and the terminal “CSVtypeA1L”, between the terminal “CSVtypeA2R” and the terminal “CSVtypeA2L”, between the terminal “CSVtypeA3R” and the terminal “CSVtypeA3L”, and between the terminal “CSVtypeA4R” and the terminal “CSVtypeA4L”, each in the gate driver 1 illustrated in FIG. 1. This is common between cases where the buffer 210 illustrated in FIG. 2 is used as the buffer 21A illustrated in FIG. 1 or is used as the buffer 21B illustrated in FIG. 1.

In the case where the buffer 210 is used as the buffer 21A illustrated in FIG. 1, the output terminal 213 of the buffer 210 is connected to the terminals “CSVtypeA1′R” to “CSVtypeA4′R” in the gate driver 1 illustrated in FIG. 1. In the case where the buffer 210 is used as the buffer 21B illustrated in FIG. 1, the output terminal 213 of the buffer 210 is connected to the terminals “CSVtypeA1′L” to “CSVtypeA4′L”, in the gate driver 1 illustrated in FIG. 1.

The two inverters 212A and 212B provided in the buffer 210 illustrated in FIG. 2 each have a power supply line VCSH connected to the terminals “VCSH” provided in the gate driver 1 illustrated in FIG. 1, and a power supply line VCSL connected to the terminals “VCSL” provided in the gate driver 1 illustrated in FIG. 1.

The inverter 212A is an inverter circuit including (i) a p-channel type MOS (Metal Oxide Semiconductor) field effect transistor 212AP in which a voltage from the terminals “VCSH” are applied to its source terminal and (ii) a n-channel type MOS field effect transistor 212AN in which a voltage from the terminal “VCSL” is applied to its source terminal.

Gate terminals of the transistors 212AP and 212AN are connected to the input terminal 211. Drain terminals of the transistors 212AP and 212AN are connected to each other, and to this connected part, the inverter 212B (gate terminals of transistors 212BP and 212BN) is connected.

The inverter 212B is an inverter circuit including (i) a p-channel type MOS field effect transistor 212BP in which a voltage from the terminal “VCSH” is applied to its source terminal and (ii) a n-channel type MOS field effect transistor 212BN in which a voltage from the terminal “VCSL” is applied to its source terminal.

The gate terminals of the transistors 212BP and 212BN are connected to the inverter 212A (connected part of the drain terminals of the transistors 212AP and 212AN). Drain terminals of the transistors 212BP and 212BN are connected to each other, and to this connected part, the output terminal 213 is connected.

Further, the buffer 210 illustrated in FIG. 2 is constructed by connecting the inverters 212A and 212B in two stages.

The following description explains a summary of a principle for generating scanning line driving signals in the scanning line driving device according to the present embodiment.

First, control signals are supplied to the terminals “LBR” of the gate driver 1 illustrated in FIG. 1, to change the terminals “LBR” to the “H” state or the “L” state. This allows determination of a shifting direction of the bidirectional shift register 12 in the gate driver 1, which thus determines a scanning direction of the scanning line driving signals. Here explained is a case where the terminals “LBR” are assumed to be made in the “H” state, in explaining the summary of the principle. At this time, the scanning direction of the scanning line driving signals outputted by the output circuit 14, that is, an order of the scanning lines to which the scanning line driving signals are supplied is: a scanning line connected to terminal “OG1”, a scanning line connected to terminal “OG2”, . . . , and a scanning line connected to terminal “OG272”.

Once scanning start signals generated based on vertical sync signals are inputted from the terminal “GSPOI” of the gate driver 1, the bidirectional shift register 12 starts the shifting operation by synchronizing with driving clock signals inputted from the terminal “GCKOI” of the gate driver 1. By this shifting operation, a first pulse that is a pulse signal is generated. As the driving clock signals, signals generated based on horizontal sync signals are used.

The first pulse is converted in level to a signal having an amplitude from the voltage vgl to the voltage vgh by a level shifter 13, and is outputted from the output circuit 14 to a scanning line connected to the terminal “OG1”. Next, by the shifting operation, the bidirectional shift register 12 generates a second pulse that is a different pulse signal from the first pulse. The second pulse is converted in level to a signal having an amplitude from the voltage vgl to the voltage vgh by the level shifter 13, and is outputted from the output circuit 14 to a scanning line connected to the terminal “OG2”.

That is to say, the bidirectional shift register 12 generates a (n+1)th pulse that is a different pulse signal from a nth pulse, by the shifting operation. The (n+1)th pulse is converted in level to a signal having an amplitude from the voltage vgl to the voltage vgh by the level shifter 13, and is outputted from the output circuit 14 to a scanning line connected to the terminal “OG(n+1)”. Next, the bidirectional shift register 12 generates a (n+2)th pulse which is a different pulse signal from the (n+1)th pulse, by the shifting operation, and keeps on repeating the above operation until a pulse (272nd pulse) is outputted to a scanning line connected to the terminal “OG272”. Here, “n”, in the case of the bidirectional shift register 12, is any arbitrary natural number between 1 to 270. In the shifting operation of the bidirectional shift register 12, signals that synchronize with the horizontal sync signals are used. Therefore, the scanning line driving signals outputted from the terminals “OG1” to “OG272” drive one corresponding scanning line per one cycle of the horizontal sync signals.

Once the shifting operation terminates, that is, after the scanning line driving signals are outputted to a scanning line connected to the terminal “OG272”, the gate driver 1 causes output of scanning start signals from the terminal “GSPIO”, and causes output of driving clock signals from the terminal “GCKIO”. The scanning start signals and the driving clock signals are inputted in the subsequent gate driver. Accordingly, in the subsequent gate driver, the scanning line driving signal generation operation starts in the scanning line driving device as similar to the gate driver 1. In a case where the gate driver 1 drives 272 scanning lines, the subsequent gate driver provides scanning line driving signals to scanning lines from the 273rd scanning line, then to the 274th scanning line, the 275th scanning line, and so on.

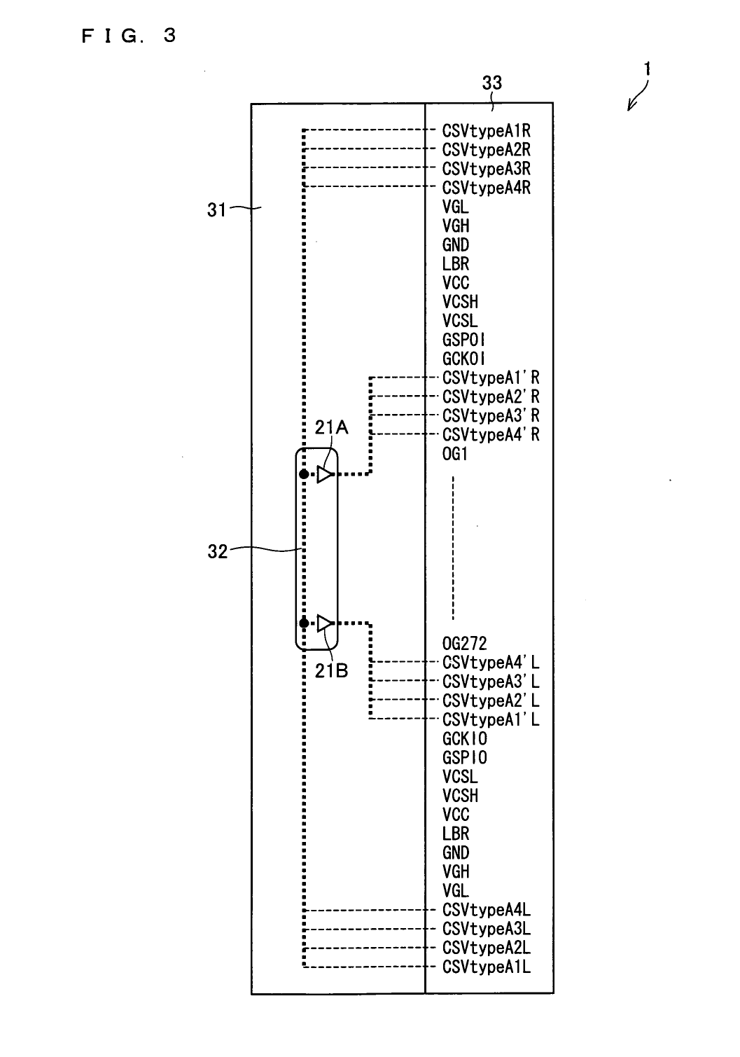

FIG. 3 illustrates an outline of the gate driver 1.

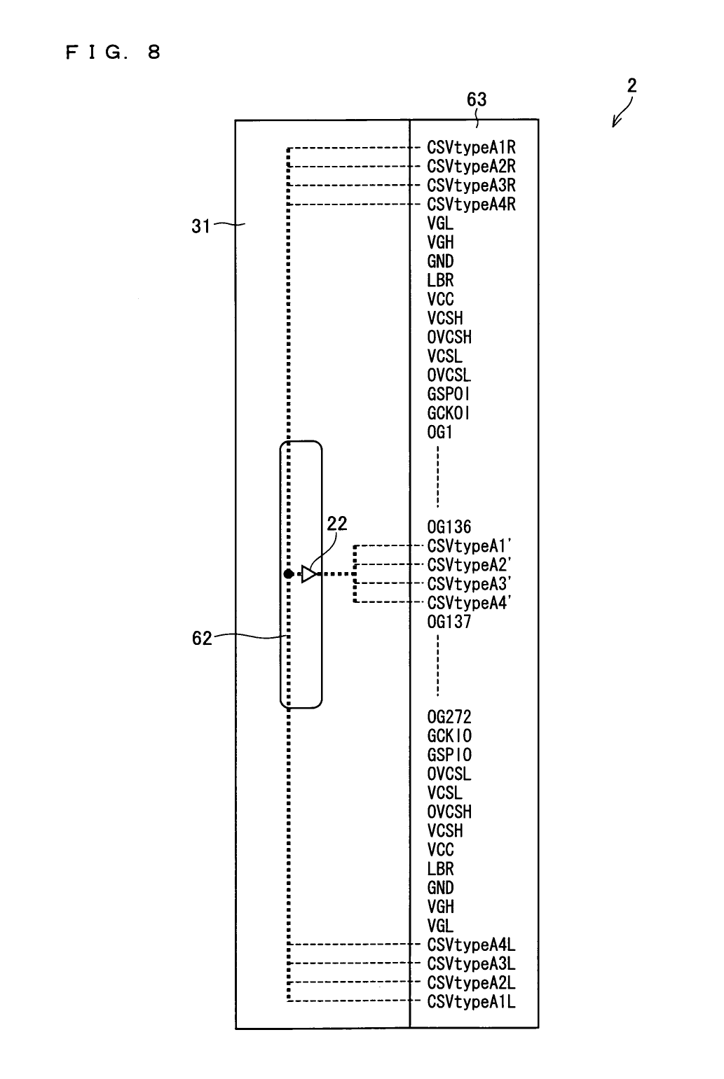

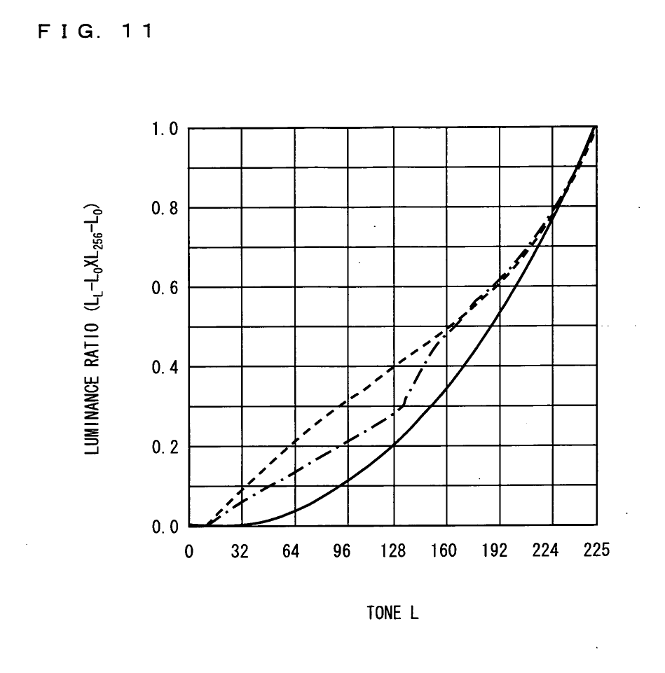

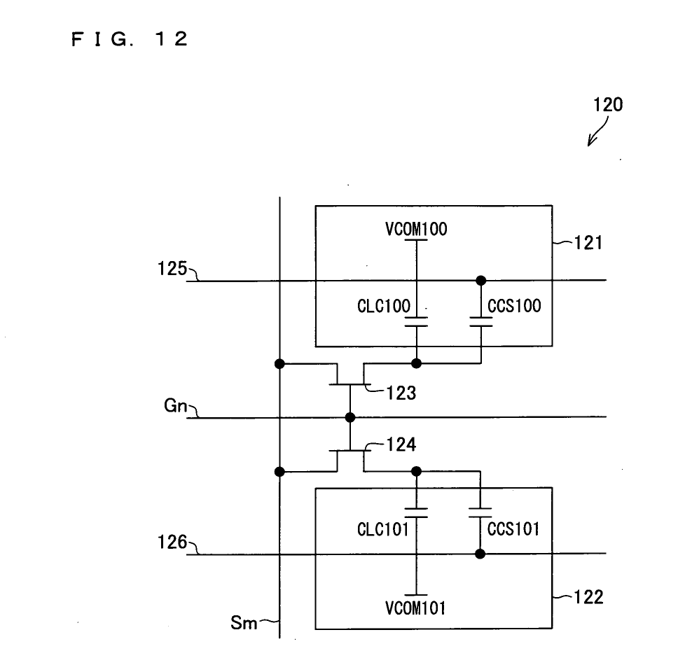

In order to further clearly illustrate the features of the scanning line driving device according to the present invention, the gate driver 1 illustrated in FIG. 3, a gate driver 2 illustrated in FIG. 8 later described, and a gate driver 3 illustrated in FIG. 10 later described are illustrated by viewing in a perspective manner the member through which the storage capacitor driving signals pass.

The gate driver 1 includes a tape 31 on which an integrated circuit 32 including the buffers 21A and 21B is mounted. Signs (letters) provided in a terminal section 33 in which various terminals are provided in the gate driver 1 illustrated in FIG. 3, are terminal names of the tape 31 that correspond to respective terminals of the gate driver 1.

The terminals of the gate driver 1 are provided in such a manner that the terminals “OG1” to “OG272” are provided in a middle part of the terminal section 33, and the terminals “CSVtypeA1′R” to “CSVtypeA4′R” and the terminals “CSVtypeA1′L” to “CSVtypeA4′L” are provided respectively on either of its sides.

Other terminals are provided on further end sides on either end of the gate driver 1 in the terminal section 33, further close to the edge than the terminals “CSVtypeA1′R” to “CSVtypeA4′R” and terminals “CSVtypeA1′L” to “CSVtypeA4′L”.

Moreover, although not illustrated, the terminals “VGL”, terminals “VGH”, terminals “GND”, terminals “LBR”, terminals “VCC”, terminals “VCSH”, and terminals “VCSL”, which two of each of the terminals are provided in FIG. 3, are provided in such a manner that one terminal and the other terminal of the two terminals are respectively connected to each other.

The terminals “CSVtypeA1R” to “CSVtypeA4R” are connected to the terminals “CSVtypeA1L” to “CSVtypeA4L”.

For convenience, in FIG. 3, FIG. 8, and FIG. 10, a section where a plurality of wires through which the storage capacitor driving signals pass (for example, wires connecting the terminal “CSVtypeA1R” and terminal “CSVtypeA1L”) exist is illustrated by one bold line.

The terminal “GSPOI” and terminal “GSPIO” have an input-output relationship in which when one is an input terminal, the other is an output terminal. That is to say, with the terminal “GSPOI” and terminal “GSPIO”, signals inputted from one of the terminals are outputted from the other one of the terminals. These terminals “GSPOI” and “GSPIO” are suitably located at either respective ends of the terminal section 33. Moreover, the terminal “GCKOI” and terminal “GCKIO” are also similarly suitably located at either respective ends of the terminal section 33.

With the buffer 21A and 21B, as described above, the input terminal of the buffer 21A and the input terminal of the buffer 21B are connected to connected parts of the terminals “CSVtypeA1R” to “CSVtypeA4R” and terminals “CSVtypeA1L” to “CSVtypeA4L”. Further, the output terminal of the buffer 21A is connected to the terminals “CSVtypeA1′R” to “CSVtypeA4′R”, and the output terminal of the buffer 21B is connected to the terminals “CSVtypeA1′L” to “CSVtypeA4′L”.

FIG. 4 is a view illustrating a state in which the gate driver 1 is mounted on a substrate of a display device.

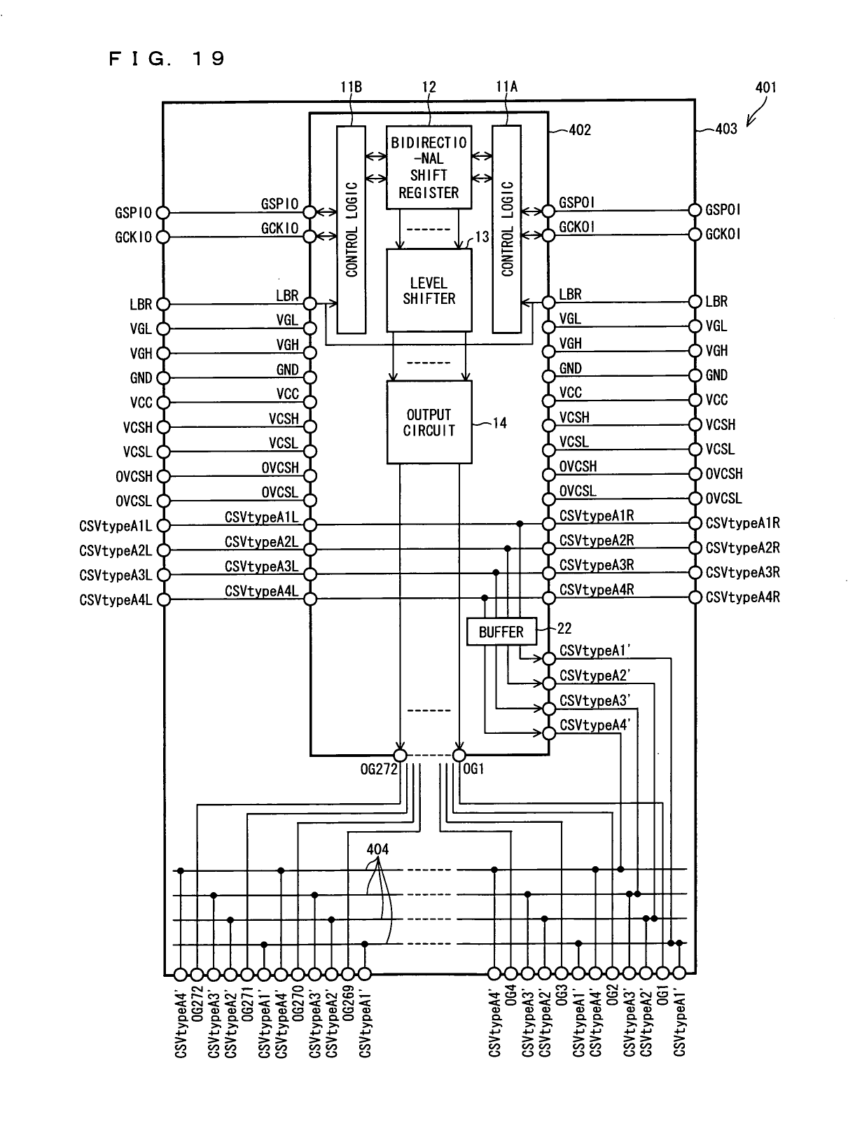

In order to further clearly illustrate the features of the display device according to the present invention, the liquid crystal display panel (display device) 40 illustrated in FIG. 4, a liquid crystal display panel 170 illustrated in FIG. 17 later described, and a liquid crystal display panel 180 illustrated in FIG. 18 later described are illustrated so that an inside of the gate driver provided in its liquid crystal display panel is partially illustrated, that is, a member in the gate driver through which no scanning line driving signal passes is illustrated, in a perspective manner.

FIG. 4, FIG. 17 later described, and FIG. 18 later described each describe, as the display device according to the present invention, a scanning line driving device in which two scanning line driving devices according to the present invention are mounted. However, the present invention is not limited to this. That is to say, the display device may have just one scanning line driving device according to the present invention mounted on its substrate, or may have three or more thereof mounted on its substrate.

The following description explains a configuration of a display device according to the present invention and its principle of operation, with reference to FIG. 4.

As shown in FIG. 4, in a liquid crystal display panel 40, one display picture element 41 is divided into a plurality of sub-picture elements 42 and 43. The sub-picture element 42 is connected to a scanning line Gn and a signal line (data line) Sm via a TFT 44. Moreover, the sub-picture element 43 is connected to the scanning line Gn and the signal line Sm via a TFT 45. That is to say, gate electrodes of the TFT 44 and TFT 45 are connected to a common (identical) scanning line Gn. Also, source electrodes of the TFT 44 and TFT 45 are connected to a common (identical) signal line Sm.

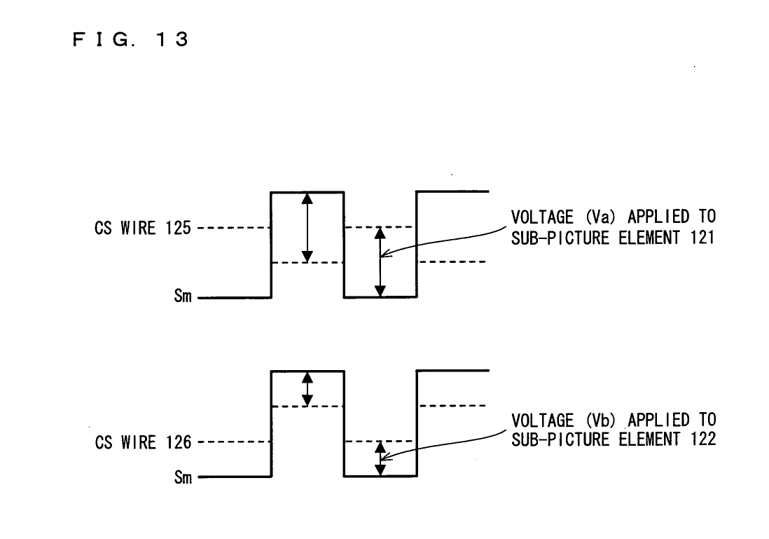

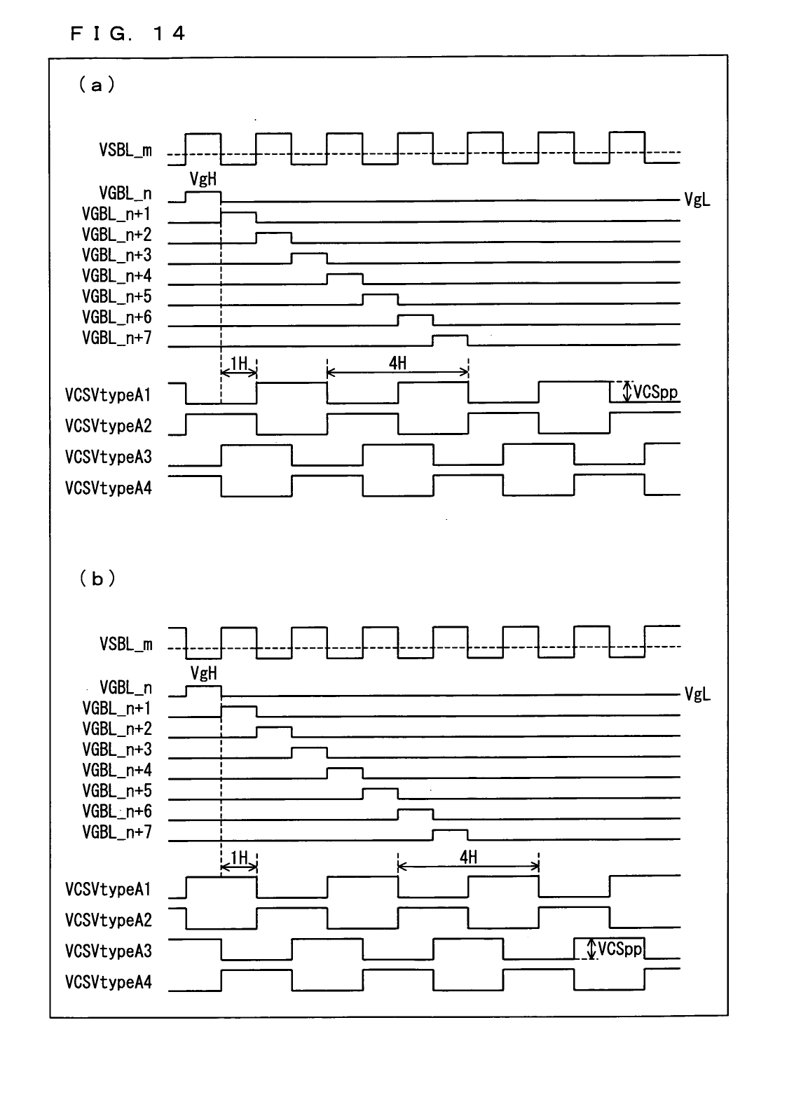

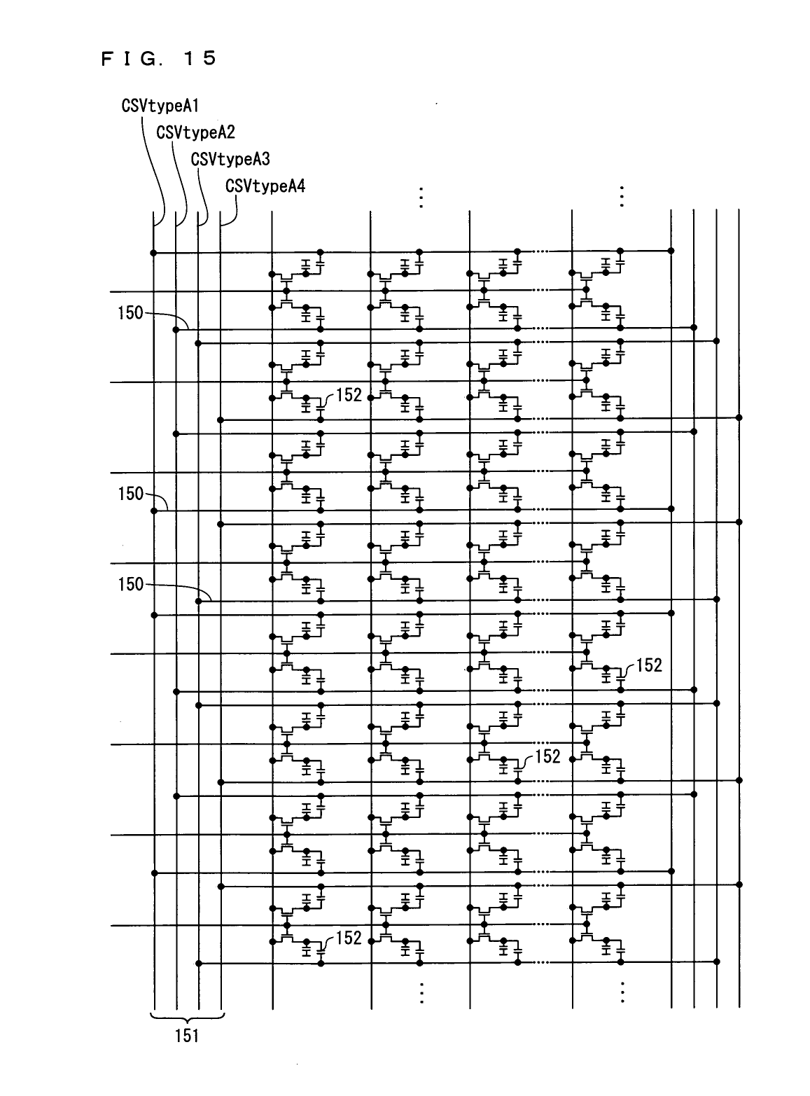

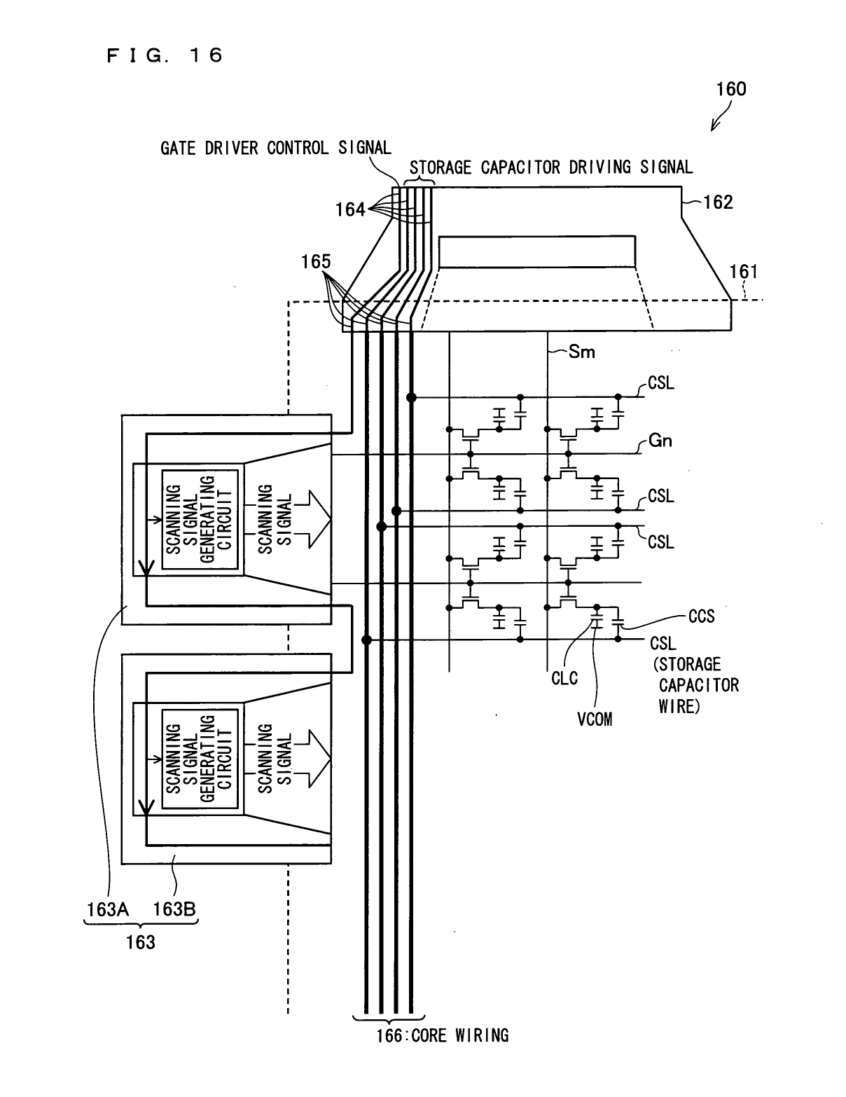

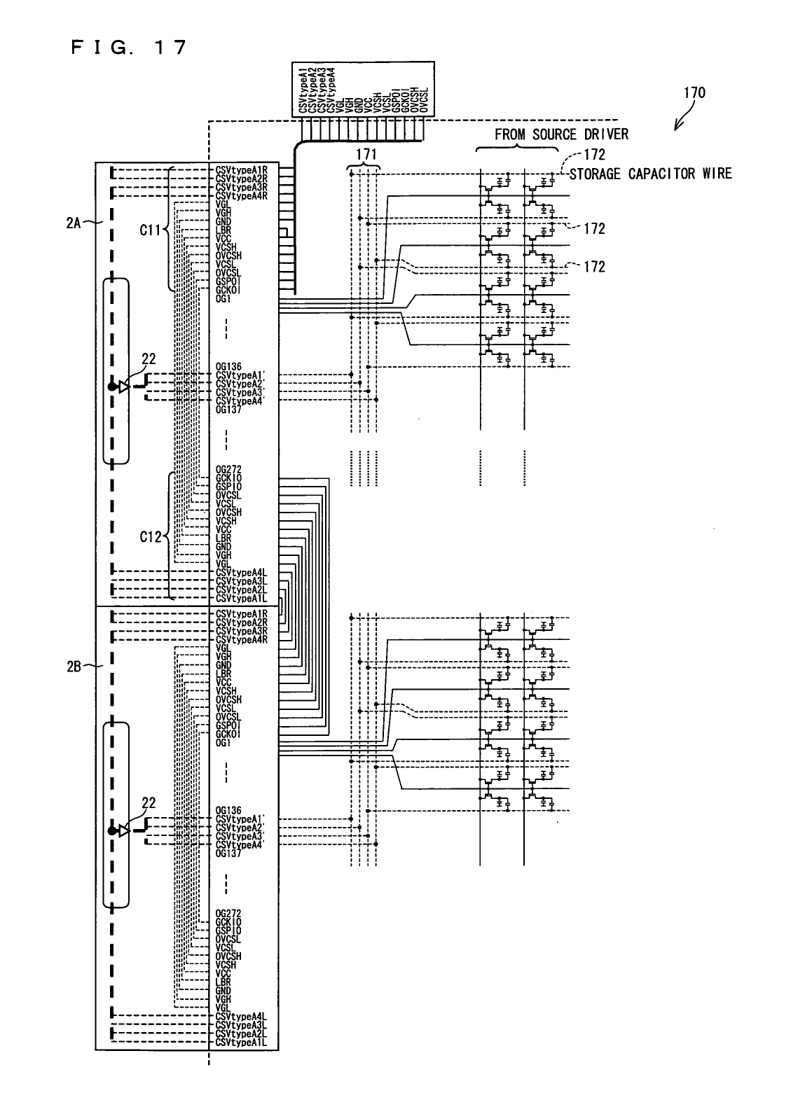

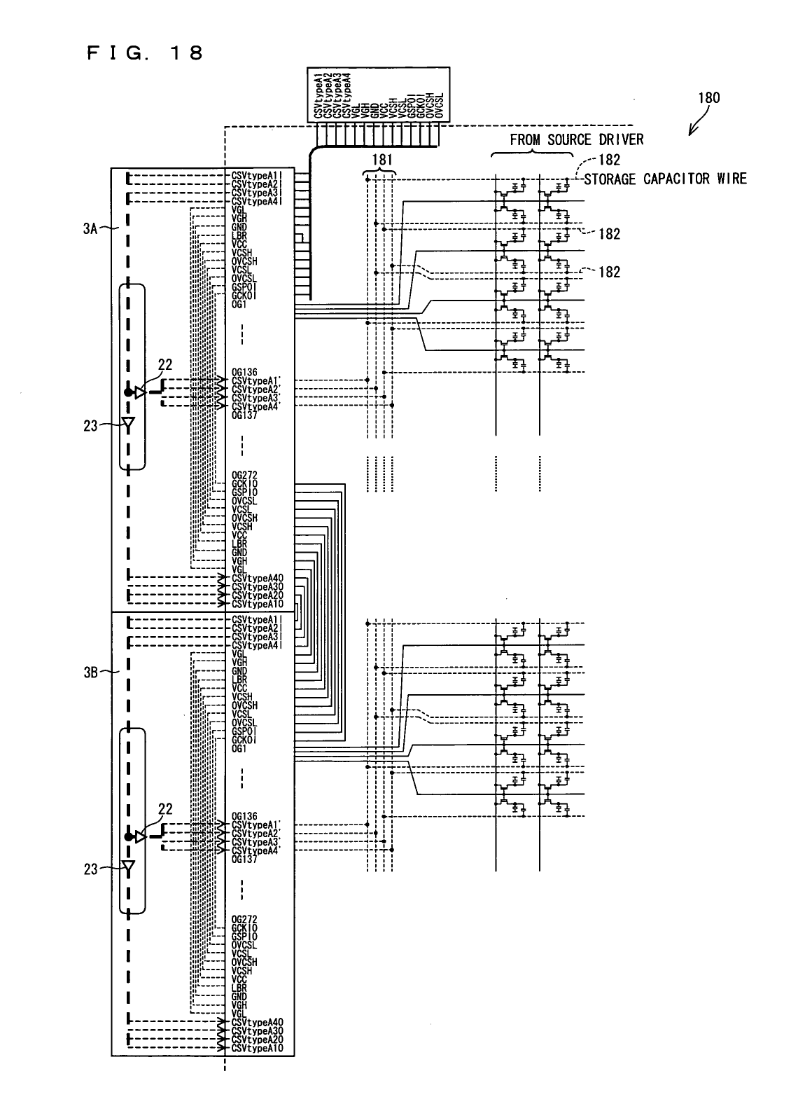

The sub-picture elements 42 and 43 each have a liquid crystal capacitor and a storage capacitor. The liquid crystal capacitors and storage capacitors have one of its electrodes connected to a drain electrode of a corresponding TFT 44 or TFT 45. The other one of the electrodes of the liquid crystal capacitor is connected to a corresponding counter voltage. The other one of the electrodes of the storage capacitor is connected to a storage capacitor wire 46 and storage capacitor wire 47, respectively. With such a configuration, the storage capacitors of the sub-picture elements 42 and 43 can be applied a CS voltage from the storage capacitor wires 46 and 47, respectively. That is to say, the sub-picture elements 42 and 43 have a similar connection relationship with the sub-picture elements 121 and 122 illustrated in FIG. 12. Consequently, a CS voltage applied to the storage capacitor of the sub-picture element 42 and a CS voltage applied to the storage capacitor of the sub-picture element 43 may be of a different voltage.

Namely, the display picture element 41 illustrated in FIG. 4 has a similar configuration as the display picture element 120 illustrated in FIG. 12.

In the liquid crystal display panel 40, storage capacitor driving signals, control signals of the gate driver (scanning start signals and driving clock signals) that are a basis of scanning line driving signals, and various power supply voltages are inputted from a controller 48 to a gate driver 1A having an identical configuration as the gate driver 1 illustrated in FIG. 1. At this time, the gate driver 1A is fixed as the “H” state, by having the terminals “LBR” and the terminal “VCC” of terminal group C1 being connected to each other.

The gate driver 1A receives storage capacitor driving signals via terminals “CSVtypeA1R” to “CSVtypeA4R” of the terminal group C1. Moreover, since the terminals “LBR” of the gate driver 1A are in the “H” state, the control signals of the gate driver are inputted via the terminal “GSPOI” and terminal “GCKOI” in the terminal group C1 of the gate driver 1A. Moreover, the various power supply voltages are inputted via the terminals “VGL”, “VGH”, “GND”, “VCC”, “VCSL”, and “VCSH”, each in the terminal group C1 of the gate driver 1A.

Here, in FIG. 4, one of each of the terminals “LBR”, terminals “VGL”, terminals “VGH”, terminals “GND”, terminals “VCC”, terminals “VCSL”, and terminals “VCSH”, are provided on each end of the terminal section 33 of the tape 31 in the gate driver 1A, as illustrated in the terminal groups C1 and C2. These terminals provided in the terminal group C1 are connected to respective terminals having the identical terminal names provided in the terminal group C2.

Moreover, as shown in FIG. 4, if the terminal “GSPOI” and the terminal “GCKOI” are provided in the terminal group C1, the terminal “GSPIO” and the terminal “GCKIO” are provided in the terminal group C2. In this case, the terminal “GSPOI” provided in the terminal group C1 is connected to the terminal “GSPIO” provided in the terminal group C2, and the terminal “GCKOI” provided in the terminal group C1 is connected to the terminal “GCKIO” provided in the terminal group C2.

Similarly, as shown in FIG. 4, if the terminals “CSVtypeA1R” to “CSVtypeA4R” are provided in the terminal group C1, the terminals “CSVtypeA1L” to “CSVtypeA4L” are provided in the terminal group C2. Further, the terminals “CSVtypeA1R” to “CSVtypeA4R” provided in the terminal group C1 are connected to the terminals “CSVtypeA1L” to “CSVtypeA4L” provided in the terminal group C2.

Furthermore, in the liquid crystal display panel 40, by connecting the terminals “CSVtypeA1L” to “CSVtypeA4L” provided in the terminal group C2 of the gate driver 1A with terminals “CSVtypeA1R” to “CSVtypeA4R” provided in a terminal group C1 of a gate driver 1B that has an identical configuration as the gate driver 1A, which terminals are connected for example via wiring on a glass substrate 49, it is possible to supply, from the gate driver 1A to the gate driver 1B, the storage capacitor driving signals, the control signals of the gate driver, and various power supply voltages that are inputted to the gate driver 1A.

Next, in the liquid crystal display panel 40, the gate driver 1A generates scanning line driving signals by the above described principle, with use of the signals serving as a basis of the scanning line driving signals which are inputted from the controller 48. Terminals “OG1” to “OG272” of the gate driver 1A are connected to corresponding scanning lines Gn of the liquid crystal display panel 40. Further, the gate driver 1A provides scanning line driving signals to each of the scanning lines Gn connected to the corresponding terminals “OG1” to “OG272”.

On the other hand, the storage capacitor driving signals inputted from the controller 48 are shaped in waveform at the buffers 21A and 21B provided inside the integrated circuit 32 of the gate driver 1A, and this signal is outputted from the terminals “CSVtypeA1′R” to “CSVtypeA4′R” and terminals “CSVtypeA1′L” to “CSVtypeA4′L”. The terminals “CSVtypeA1′R” to “CSVtypeA4′R” and terminals “CSVtypeA1′L” to “CSVtypeA4′L” are connected to respective core lines (core wiring) 50 of storage capacitors in the liquid crystal display panel 40. Furthermore, storage capacitor wires 51 are connected to respective core lines 50. The storage capacitor driving signals outputted from the buffer 21A and 21B to the terminals “CSVtypeA1′R” to “CSVtypeA4′R” and terminals “CSVtypeA1′L” to “CSVtypeA4′L”, which signals are reduced in waveform rounding, are provided to all storage capacitor wires 51 that are connected to the terminals “CSVtypeA1′R” to “CSVtypeA4′R” and the terminals “CSVtypeA1′L” to “CSVtypeA4′L”. By providing the signals thereto, the storage capacitors connected to the storage capacitor wires 51 are caused to drive.

According to the foregoing configuration, the core lines 50 can be divided into units of storage capacitor wires 51 that are respectively connected to terminals “CSVtypeA1′R” to “CSVtypeA4′R” and terminals “CSVtypeA1′L” to “CSVtypeA4′L” of the gate driver 1A. The core lines 50 can be provided in a divided state per set of the storage capacitor wires 51 that are connected to one specific one buffer.

As described above, the liquid crystal display panel 40 illustrated in FIG. 4 includes the gate drivers 1A and 1B into which storage capacitor driving signals are inputted. Further, each of the gate drivers 1A and 1B include buffers 21A and 21B, which buffers 21A and 21B each receives the storage capacitor driving signals and shapes a waveform of the storage capacitor driving signals. Furthermore, each of the buffers 21A and 21B supplies to the storage capacitor wires 51 the storage capacitor driving signals reduced in waveform rounding, by shaping the waveform of the inputted storage capacitor driving signals and outputting the signals rounded in waveform to the storage capacitor wires 51.

The display device according to the present invention requires providing a core wiring, however no core wiring is required to be extended along a whole of the liquid crystal display panel, as like in a display device according to a conventional technique. Namely, the display device according to the present invention requires no driving of a storage capacitor that is connected to storage capacitor wires of the entire liquid crystal display panel, as with the display device according to the conventional technique. Therefore, in the display device according to the present invention, it is possible to narrow a line width of wires that construct the core wiring as compared to a line width of wires constructing a core wiring provided in a display device according to the conventional technique. However relevant to a size of the buffer and thus cannot be said unconditionally, in a case where a storage capacitor is driven by four gate drivers in a display device according to the conventional technique, by employing a configuration of the liquid crystal display panel 40 illustrated in FIG. 4 instead of the display device, it is possible to divide the core wiring of the display device according to the conventional technique into eight core wirings. Therefore, the liquid crystal display panel 40 illustrated in FIG. 4 allows the line width of the wire that construct the core lines 50 to be made for example in a width ⅛ of the line width of the core wiring in the display device according to a conventional technique.

Therefore, the display device according to the present invention can realize narrowing of frame.

The display device according to the present invention may have one or a plurality of buffers having the aforementioned functions, per scanning line driving device provided in the display device, without having the core wiring divided. Further, the storage capacitor driving signals may be supplied to each of the storage capacitor wires from each of the buffer(s). This is possible by having each of the scanning line driving devices be mounted in a dispersed manner on the display device, and also having the plurality of buffers being provided inside the display device be mounted in a dispersed manner together with the scanning line driving devices. In this case, if a total driving ability of the buffers is sufficiently high, the line width of the wires that construct the core wiring may be made narrow, without dividing the core lines.

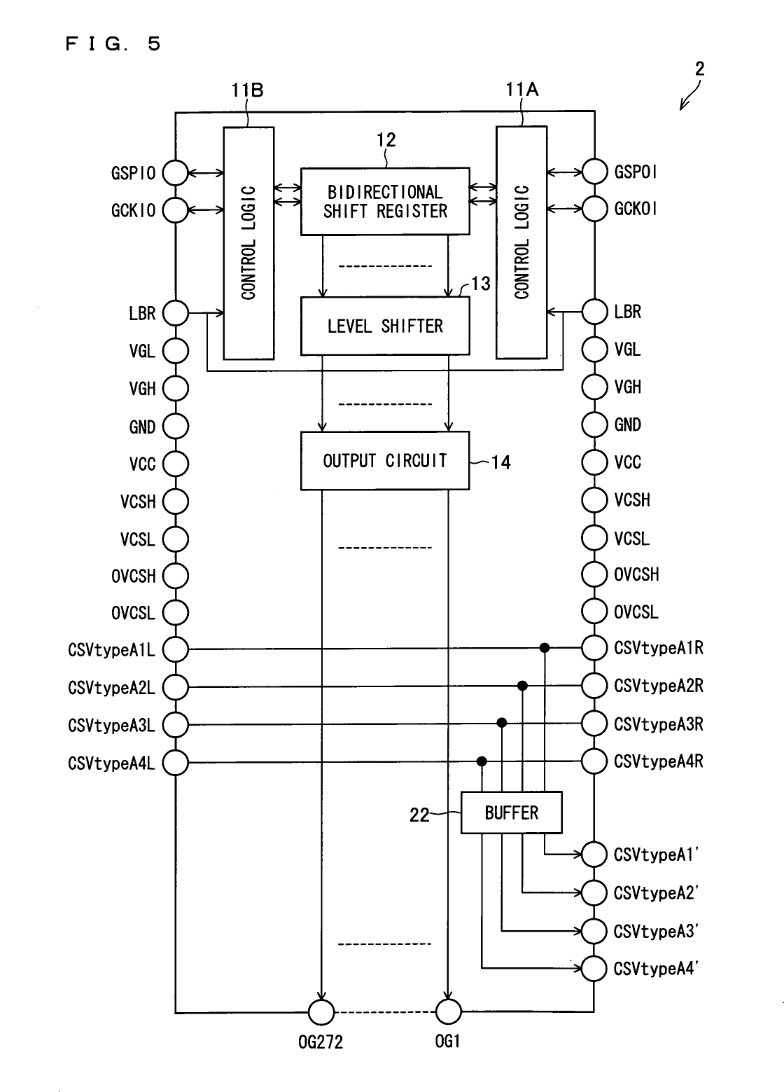

FIG. 5 illustrates another embodiment of the present invention, and is a block diagram schematically illustrating a scanning line driving device.

A gate driver 2 illustrated in FIG. 5 has, as compared to the configuration of the gate driver 1 illustrated in FIG. 1, the terminals “CSVtypeA1′R” to “CSVtypeA4′R”, or the terminals “CSVtypeA1′L” to “CSVtypeA4′L” omitted from its configuration. Namely, the gate driver 2 illustrated in FIG. 5 has one set of terminals “CSVtypeA1′” to “CSVtypeA4′” as output terminals of the storage capacitor driving signals.

Moreover, the gate driver 2 illustrated in FIG. 5, as compared to the configuration of the gate driver 1 illustrated in FIG. 1, adds terminals “OVCSH” and terminals “OVCSL”.

The gate driver 2 illustrated in FIG. 5 includes one buffer 22. In accordance with this, in the present embodiment, the terminals “VCSH” and the terminals “VCSL” serve as power supply terminals to which a power supply not illustrated is connected, for causing operation of the buffer 22.

The terminals “OVCSH” and the terminals “OVCSL” are, as with the terminals “VCSH” and the terminals “VCSL”, power supply terminals to which a power supply not illustrated is connected, for causing operation of the buffer 22. In the embodiment, a power supply voltage applied to the terminals “OVCSH” is several V higher than a power supply voltage applied to the terminals “VCSH”. Moreover, a power supply voltage applied to the terminals “OVCSL” is several V lower than a power supply voltage applied to the terminals “VCSL”.

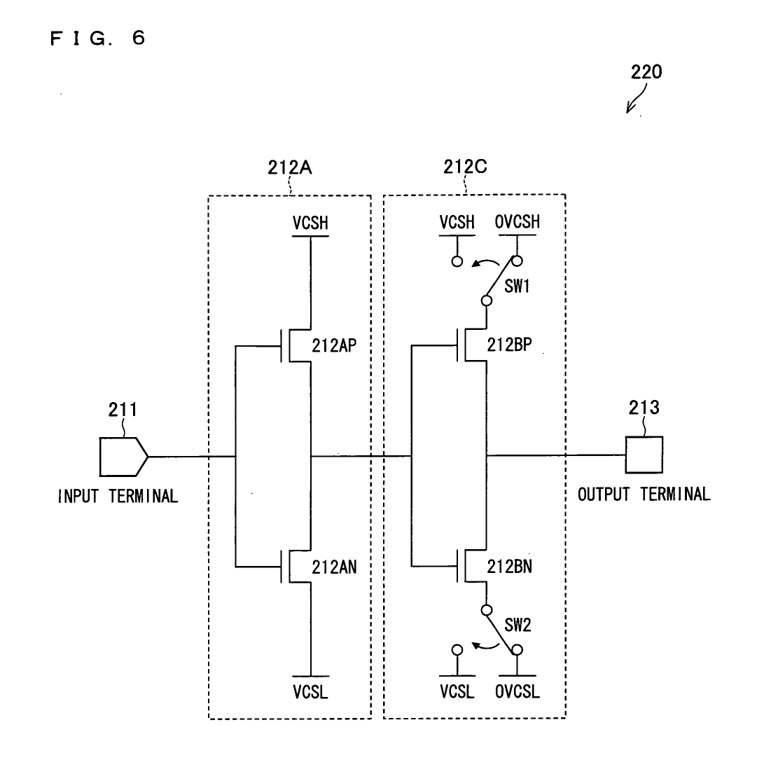

FIG. 6 is a view illustrating another circuit configuration of the buffer.

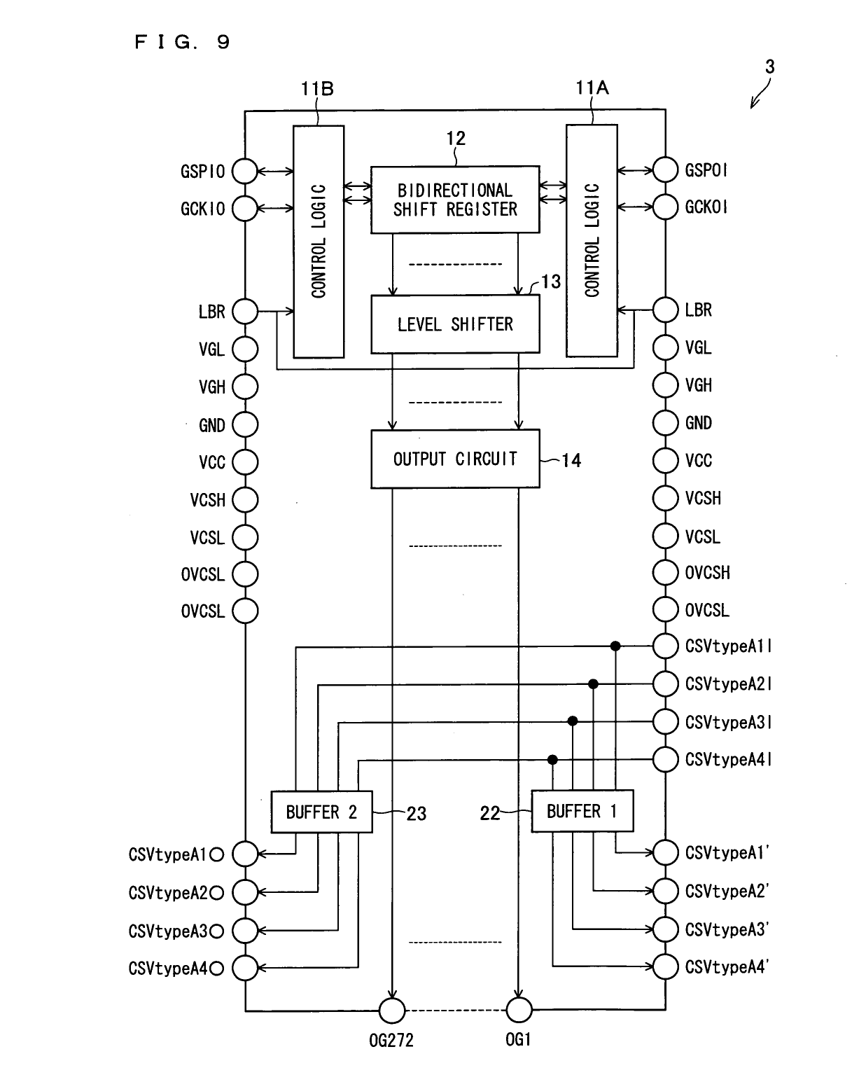

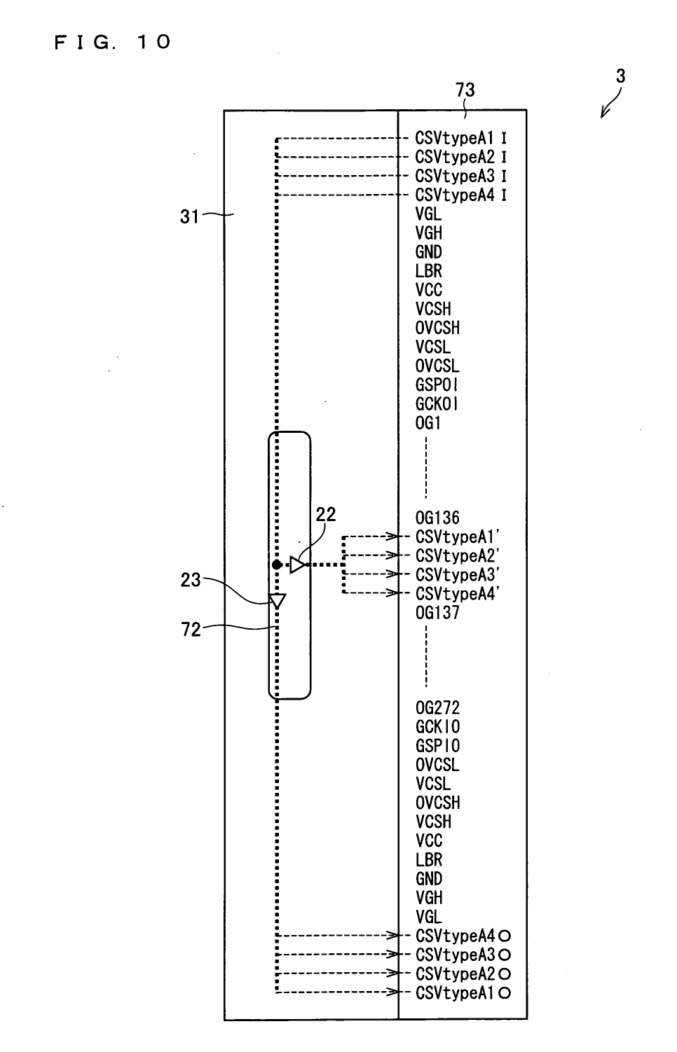

A buffer 220 illustrated in FIG. 6 is suitably usable as the buffer 22 and a buffer 23 later described (see FIG. 9). The buffer 220 illustrated in FIG. 6, as compared to the configuration of the buffer 210 illustrated in FIG. 2, includes an inverter circuit 212C instead of the inverter 212B. The inverter circuit 212C, as compared to the configuration of the inverter 212B, further has a switch SW1 at a source terminal of the transistor 212BP, and further has a switch SW2 at a source terminal of the transistor 212BN.

Both the switch SW1 and switch SW2 are, for example, a single pole changeover switch that carries out a changeover contact operation. The switch SW1, by switching ON and OFF, causes a connection changeover of the source terminal of the transistor 212BP to be connected to either the terminal “VCSH” or the terminal “OVCSH”. The switch SW2, by switching ON and OFF, causes a connection changeover of the source terminal of the transistor 212BN to be connected to either the terminal “VCSL” or the terminal “OVCSL”.

In the embodiment, via the switch SW1, the source terminal of the transistor 212BP is connected to the terminal “OVCSH” for a predetermined time from a moment the storage capacitor driving signal inputted from the input terminal 211 rises, and for times other than this, the source terminal of the transistor 212BP is connected to the terminal “VCSH”. Similarly, via the switch SW2, the source terminal of the transistor 212BN is connected to the terminal “OVCSL” for a predetermined time from a moment the storage capacitor driving signal falls, and for times other than this, the source terminal of the transistor 212BN is connected to the terminal “VCSL”.

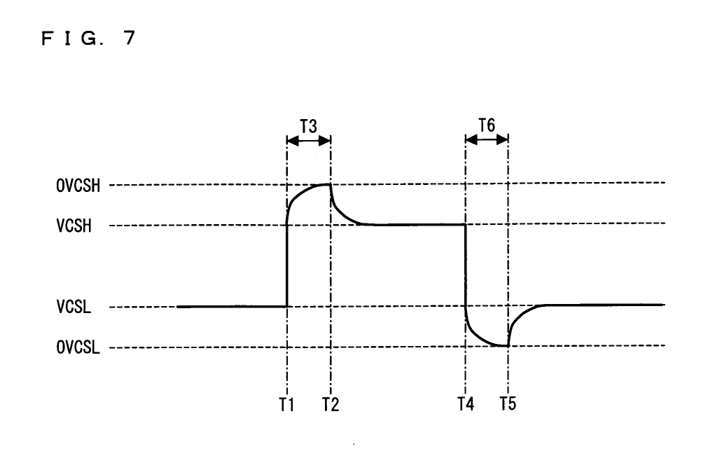

If the switching operation of the switches SW1 and SW2 are controlled as the aforementioned in the buffer 220 illustrated in FIG. 6, signals outputted by the buffer becomes a waveform as illustrated in FIG. 7.

FIG. 7 is a graph illustrating a waveform of a signal which has been subjected to a so-called overshooting process by the buffer 220. In the graph illustrated in FIG. 7, the vertical axis represents a level of the storage capacitor driving signal, and the horizontal axis represents time.

The switch SW1 causes connection of the source terminal of the transistor 212BP and the terminal “OVCSH” having an electric potential several V higher than that of the terminal “VCSH” during T3, which is a time between a moment T1 the storage capacitor driving signal whose waveform is illustrated in FIG. 7 rises to T2 that is a moment following elapse of a predetermined time from the rising moment of T1. During times other than the T3, the switch SW1 causes connection of the source terminal of the transistor 212BP with the terminal “VCSH”.

The switch SW2 causes connection of the source terminal of the transistor 212BN with the terminal “OVCSL” having an electric potential several V lower than that of the terminal “VCSL” during T6, which is a time between a moment T4 the storage capacitor driving signal whose waveform is illustrated in FIG. 7 falls to T5 that is a moment following elapse of a predetermined time from the falling moment of T4. During times other than T6, the switch SW2 causes connection of the source terminal of the transistor 212BN with the terminal “VCSL”.

The gate driver 2 illustrated in FIG. 5 uses the buffer 220 illustrated in FIG. 6 as the buffer 22. The gate driver 2 illustrated in FIG. 5 carries out an overshooting process as illustrated in FIG. 7 to the storage capacitor driving signals inputted to the buffer 22 via the terminals “CSVtypeA1R” to “CSVtypeA4R”, and outputs these signals via the terminals “CSVtypeA1′” to “CSVtypeA4′”. This allows the gate driver 2 illustrated in FIG. 5 to once output, by the overshooting process, an electric potential higher than a voltage to be outputted, at the rise of the storage capacitor driving signal, and thereafter, outputs a target electric potential. Similarly, the gate driver 2 illustrated in FIG. 5 once outputs, by the overshooting process, an electric potential lower than a voltage to be outputted, at a fall of the storage capacitor driving signal, and thereafter, outputs the target electric potential. This allows shortening a time for charging the storage capacitor and liquid crystal capacitor, thereby shortening the time to reach the target voltage. Further, this allows the gate driver 2 illustrated in FIG. 5 to operate even in a case where a driving time of the storage capacitor shortens due to an increase in the number of scanning lines. Namely, the gate driver 2 illustrated in FIG. 5 can appropriately drive the storage capacitor even if the driving time of the storage capacitor is shortened due to the increase in the number of scanning lines. Hence, it is possible to reduce unevenness in display luminance, thereby reducing the unevenness in display.

FIG. 8 is a view illustrating one example of an outline of the gate driver 2 illustrated in FIG. 5.

The gate driver 2 illustrated in FIG. 8 includes a tape 31 on which an integrated circuit 62 including the buffer 22 is mounted. Moreover, the gate driver 2 illustrated in FIG. 8 has a terminal section 63.

In the gate driver 2 illustrated in FIG. 8, the terminal section 63 has the terminals “CSVtypeA1′” to “CSVtypeA4′” provided in a middle part of the terminal section 63.

Moreover, the terminals “OVCSH” are provided sandwiched between respective terminals “VCSH” and terminals “VCSL” in the terminal section 63. Moreover, one of the terminals “OVCSL” is provided sandwiched between one of the terminals “VCSL” and the terminal “GSPOI” in the terminal section 63, and the other one of the terminals “OVCSL” is provided sandwiched between the other one of the terminals “VCSL” and the terminal “GSPIO” in the terminal section 63.

Furthermore, the gate driver 2 illustrated in FIG. 8 can be mounted, as shown in FIG. 17, in the similar fashion as FIG. 4, as the gate drivers 2A and 2B in a liquid crystal display panel 170 that serves as a display device. One of the terminals “OVCSH” and terminals “OVCSL” are provided in a terminal group C11 (a terminal group corresponding to the terminal group C1 of the gate driver 1A illustrated in FIG. 4) according to the liquid crystal display panel 170 illustrated in FIG. 17, and the other one of the terminals “OVCSH” and terminals “OVCSL” are provided in a terminal group C12 (a terminal group corresponding to the terminal group C2 of the gate driver 1A illustrated in FIG. 4). The terminal “OVCSH” provided in the terminal group C11 is connected to the terminal “OVCSH” provided in the terminal group C12, and the terminal “OVCSL” provided in the terminal group C11 is connected to the terminal “OVCSL” provided in the terminal group C12. The terminals “CSVtypeA1′” to “CSVtypeA4′” are connected to a core wiring 171 of storage capacitors in the liquid crystal display panel 170. Furthermore, the core wiring 171 is connected to storage capacitor wires such as storage capacitor wires 172. The storage capacitor driving signals that are outputted from the buffer 22 to the terminals “CSVtypeA1′” to “CSVtypeA4′” and which are reduced in waveform rounding, are provided to all of the storage capacitor wires connected to the terminals “CSVtypeA1′” to “CSVtypeA4′”.

With the liquid crystal display panel 170 illustrated in FIG. 17, a similar effect is attained as with the liquid crystal display panel 40 illustrated in FIG. 4.

In the embodiment according to FIG. 5, the buffer 220 illustrated in FIG. 6 is used as the buffer 22. However, the present invention is not limited to this, and the buffer 210 illustrated in FIG. 2 may also be used as the buffer 22. Moreover, the other way round, the buffer 220 illustrated in FIG. 6 may be used as the buffer 21A and/or the buffer 21B in the embodiment according to the aforementioned FIG. 1.

FIG. 9 illustrates yet another embodiment of the present invention, and is a block diagram schematically illustrating a scanning line driving device.

A gate driver 3 illustrated in FIG. 9 further includes, as compared to the gate driver 2 illustrated in FIG. 5, a buffer (second buffer) 23. In accordance with this, in the present embodiment, the terminals “VCSH” and terminals “VCSL” serve as power supply terminals to which a power supply not illustrated is connected, for operating the buffer (first buffer) 22 and buffer 23.

Moreover, the gate driver 3 illustrated in FIG. 9 has terminals “CSVtypeA1I” to “CSVtypeA4I” and terminals “CSVtypeA1O” to “CSVtypeA4O” provided instead of the terminals “CSVtypeA1R” to “CSVtypeA4R” and terminals “CSVtypeA1L” to “CSVtypeA4L”.

The terminals “CSVtypeA1I” to “CSVtypeA4I” provided in the gate driver 3 are input terminals of the storage capacitor driving signals, for inputting the storage capacitor driving signals to the buffer 23. The terminals “CSVtypeA1O” to “CSVtypeA4O” provided in the gate driver 3 are output terminals of the storage capacitor driving signals, for outputting the storage capacitor driving signals inputted from the buffer 23 to a destination different from the storage capacitor wires.

That is to say, the terminals “CSVtypeA1O” to “CSVtypeA4O” provided in the gate driver 3 that are connected to terminals “CSVtypeA1I” to “CSVtypeA4I” of a subsequent gate driver (not illustrated) having an identical configuration as the gate driver 3 allows supplying the storage capacitor driving signals to the subsequent gate driver. For example, in a case where two of the gate drivers 3 illustrated in FIG. 8 (namely, gate drivers 3A and 3B illustrated in FIG. 18 later described) are mounted in the similar fashion as illustrated in FIG. 4 as the scanning line driving device according to the present invention, the terminals “CSVtypeA1O” to “CSVtypeA4O” provided in the gate driver 3A are connected to the terminals “CSVtypeA1I” to “CSVtypeA4I” provided in the gate driver 3B (see FIG. 18).

The buffer 23 has one of its ends (input terminal) connected to the terminals “CSVtypeA1I” to “CSVtypeA4I” of the gate driver 3, and has the other one of its ends (output terminal) connected to the terminals “CSVtypeA1O” to “CSVtypeA4O” of the gate driver 3. The buffer 23 is provided between the terminals “CSVtypeA1I” to “CSVtypeA4I” and the terminals “CSVtypeA1O” to “CSVtypeA4O”, at a closer part to the terminals “CSVtypeA1O” to “CSVtypeA4O” than a part where the buffer 22 is connected.

In the gate driver 3 illustrated in FIG. 9, the storage capacitor driving signals inputted from the terminals “CSVtypeA1I” to “CSVtypeA4I” are outputted to the storage capacitor wires from the terminals “CSVtypeA1′” to “CSVtypeA4′”, via the buffer 22.

On the other hand, in the gate driver 3 illustrated in FIG. 9, the storage capacitor driving signals inputted from the terminals “CSVtypeA1I” to “CSVtypeA4I” are outputted from the terminals “CSVtypeA1O” to “CSVtypeA4O” to a destination different from the storage capacitor wires (for example, the subsequent gate driver), via the buffer 23.

Hence, in a display device including a plurality of scanning line driving devices, it is possible to suppress varying of waveform of the storage capacitor driving signals between the plurality of scanning line driving devices, which varying is caused by rounding and delay of the storage capacitor driving signals.

Therefore, the gate driver 3 illustrated in FIG. 9 is extremely effective in a case where a large number of scanning line driving devices are mounted in a display device.

The buffer used as the buffer 23 may of course be the buffer 210 illustrated in FIG. 2, however it is more suitable to use the buffer 220 illustrated in FIG. 6.

FIG. 10 is a view illustrating an outline of the gate driver 3 illustrated in FIG. 9.

The gate driver 3 illustrated in FIG. 10 includes a tape 31 on which an integrated circuit 72 including the buffer 22 and 23 are mounted. Moreover, the gate driver 3 illustrated in FIG. 10 has a terminal section 73. In the gate driver 3 illustrated in FIG. 10, the terminals “CSVtypeA1I” to “CSVtypeA4I” are provided on one of ends of the terminal section 73, and the terminals “CSVtypeA1O” to “CSVtypeA4O” are provided on the other one of ends of the terminal section 73.

Furthermore, the gate driver 3 illustrated in FIG. 9 may be mounted as the gate drivers 3A and 3B in the similar fashion as FIG. 4 in the liquid crystal display panel 180 serving as a display device, as shown in FIG. 18.

The liquid crystal display panel 180 illustrated in FIG. 18 includes the gate drivers 3A and 3B into which storage capacitor driving signals are inputted. Further, each of the gate drivers 3A and 3B has buffers 22 and 23 that receive the storage capacitor driving signals thus inputted in the gate drivers 3A and 3B. The buffer 22 shapes waveforms of the inputted storage capacitor driving signals, and outputs the storage capacitor driving signals via the terminals “CSVtypeA1′” to “CSVtypeA4′” to storage capacitor wires such as storage capacitor wires 182 connected to a core wiring 181, to supply the storage capacitor driving signals to the storage capacitor wires 182. On the other hand, the buffer 23 shapes the waveforms of the inputted storage capacitor driving signals, and outputs this to a destination different from the storage capacitor wires 182 via the terminals “CSVtypeA1O” to “CSVtypeA4O”. As one example thereof, the buffer 23 of the gate driver 3A outputs the inputted storage capacitor driving signals via the terminals “CSVtypeA1O” to “CSVtypeA4O” of the gate driver 3A to the terminals “CSVtypeA1I” to “CSVtypeA4I” of the gate driver 3B.

The display device according to the present invention may be arranged to (i) generate the storage capacitor driving signals inside the scanning line driving device, (ii) shape the waveforms of the storage capacitor driving signals by the buffer provided in the scanning line driving device, and then (iii) supply the signals thus shaped to the storage capacitor wires. Similarly, the scanning line driving device according to the present invention may be arranged to (i) generate the storage capacitor driving signals inside the scanning line driving device, (ii) shape the waveforms of the storage capacitor driving signals by a buffer provided in the scanning line driving device, and (iii) supply the signals thus shaped to the storage capacitor wires of the display device.

### Embodiment 2

FIG. 19 is a block diagram schematically illustrating a scanning line driving device provided in a display device according to the present embodiment.

A gate driver mounted substrate (scanning line driving device) 401 illustrated in FIG. 19 includes an interposer substrate (substrate) 403 on which a gate driver (integrated circuit) 402 is mounted.

The gate driver 402 includes control logics 11A and 11B, a bidirectional shift register 12, a level shifter 13, an output circuit 14, and a buffer 22, and has an identical configuration as the gate driver 2 illustrated in FIG. 5.

The following description explains functions of the terminals provided in the gate driver mounted substrate 401. Each of the terminals provided in the gate driver mounted substrate 401 are illustrated in FIG. 19 as round members. Moreover, signs (letters) provided to the round members denote the terminal names of the respective terminals provided in the gate driver mounted substrate 401. The terminals provided in the gate driver mounted substrate 401 are provided to both the gate driver 402 and the interposer substrate 403, and terminals having identical terminal names are connected to each other. With this configuration, in the gate driver mounted substrate 401, it is possible to supply inputted signals or a voltage applied from outside to the gate driver 402 via the interposer substrate 403. Further, with this configuration, in the gate driver mounted substrate 401, signals to be outputted or a voltage to be applied can be supplied externally from the gate driver 402 via the interposer substrate 403. In the present embodiment, explanations of each terminal provided in the gate driver mounted substrate 401 are provided per terminal name, regardless of whether the terminal is provided in the gate driver 402 or is provided in the interposer substrate 403.

Terminals “LBR” are input terminals into which control signals that indicate a shifting direction of the bidirectional shift register 12 are inputted. The terminals “LBR” have a state “H” and a state “L”, and control the shifting direction of the bidirectional shift register 12 by changing over between the state “H” and the state “L” in accordance with the control signals. With this configuration, a scanning direction of scanning line driving signals outputted by an output circuit 14 is determined. The output circuit 14 is a circuit provided for outputting the scanning line driving signals to terminals “OG1” to “OG272” later described.

Terminals “GSPOI” and terminals “GSPIO” are IO terminals that have a function of switching between an input terminal and an output terminal in accordance with the control signals inputted in the terminals “LBR”. When the terminals “LBR” are in the state “H”, the terminals “GSPOI” are input terminals and the terminals “GSPIO” are output terminals. When the terminals “LBR” are in the state “L”, the terminals “GSPOI” are output terminals and the terminals “GSPIO” are input terminals. Of the terminals “GSPOI” and “GSPIO”, the terminals having the input terminal function serve as terminals for inputting scanning start signals to the gate driver 402, which scanning start signals cause operation of the bidirectional shift register 12 to start. Moreover, of the terminals “GSPOI” and “GSPIO”, the terminals having the output terminal function serve as terminals for outputting the scanning start signals to a subsequent gate driver not illustrated that is cascade-connected to the gate driver 402.

The terminals “GCKOI” and the terminals “GCKIO”, similarly to the terminals “GSPOI” and the terminal “GSPIO”, are IO terminals having a changeover function switching between input terminals and output terminals in accordance with the control signals inputted in the terminals “LBR”. Namely, when the terminal “LBR” is in the state “H”, the terminals “GCKOI” are input terminals and the terminals “GCKIO” are output terminals. Further, when the terminals “LBR” are in the state “L”, the terminal “GCKOI” are output terminals and the terminals “GCKIO” are input terminals. Of the terminals “GCKOI” and the terminals “GCKIO”, the terminals having the input terminal function serve as terminals for inputting driving clock signals of the bidirectional shift register 12 to the gate driver 402. Moreover, of the terminals “GCKOI” and the terminals “GCKIO”, the terminals having the output terminal function serve as terminals for outputting the driving clock signals to the subsequent gate driver.

Terminals “VGL” and terminals “VGH” are power supply terminals to which a power supply not illustrated is connected, for operating the output circuit 14. When a power supply voltage applied to the terminals “VGL” are represented as vgl and a power supply voltage applied to the terminals “VGH” are represented as vgh, vgl is smaller than vgh. Moreover, in this case, the output circuit 14 outputs the scanning line driving signals as signals having an amplitude from vgl to vgh, to the terminals “OG1” to “OG272”.

Terminals “VCC” are power supply terminals to which a power supply not illustrated is connected, for operating the gate driver 402. Terminals “GND” are ground terminals.

The terminals “OG1” to “OG272” (second terminals) are output terminals of the scanning line driving signals, for outputting the scanning line driving signals from the output circuit 14 externally of the gate driver mounted substrate 401. The scanning lines provided in the display device are directly connected to the terminals “OG1” to “OG272”, or the scanning lines and the terminals “OG1” to “OG272” are connected via a wiring or the like, to allow supplying of the scanning line driving signals outputted from the terminals “OG1” to “OG272” to the scanning lines. The scanning lines then are driven based on the supplied scanning line driving signals. One scanning line is connectable to one of the terminals “OG1” to “OG272”. Namely, one of the terminals “OG1” to “OG272” is capable of supplying the scanning line driving signals to one scanning line. The present embodiment deals with an example in which a total of 272 scanning lines which are respectively connected to the terminals “OG1” to “OG272” are driven in the gate driver mounted substrate 401, however the present invention is not limited to this. That is to say, the scanning line driving device according to the present embodiment may have at least one terminal of the terminals “OG1” to “OG272” not connected to a scanning line (namely, the scanning line driving device may have a total of 271 scanning lines or less lines that are driven).

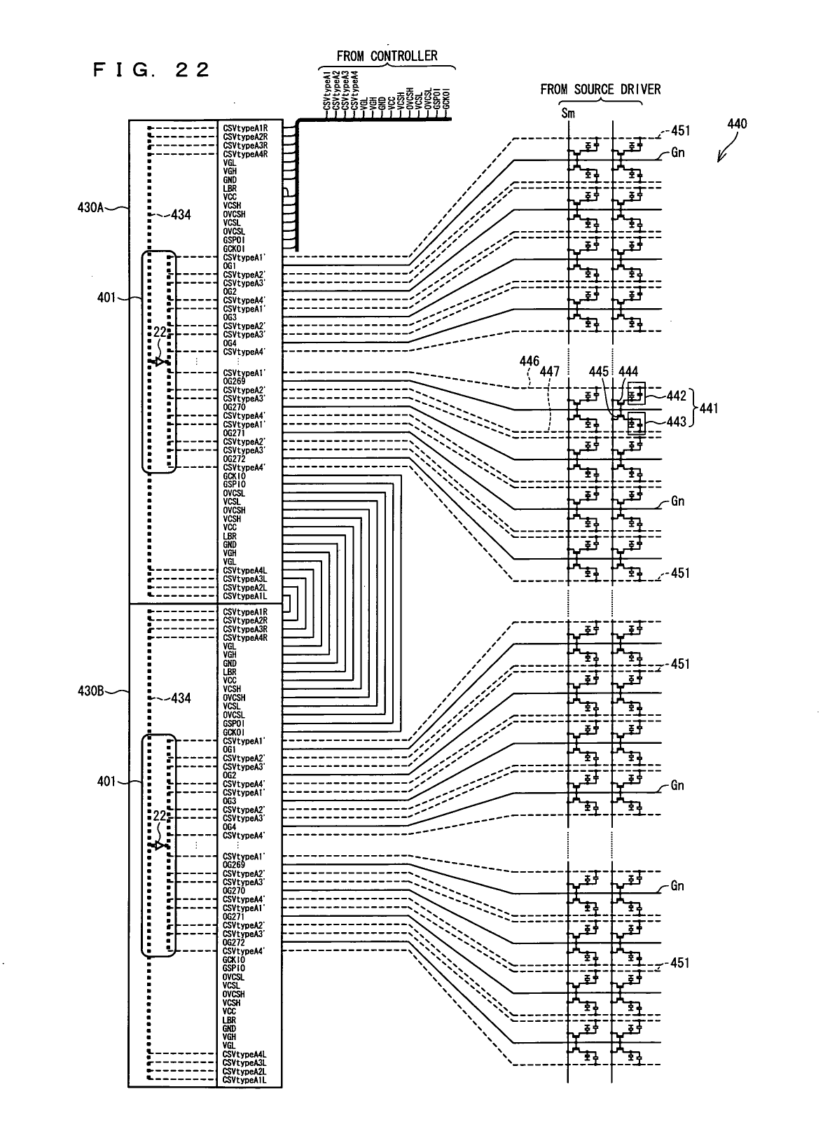

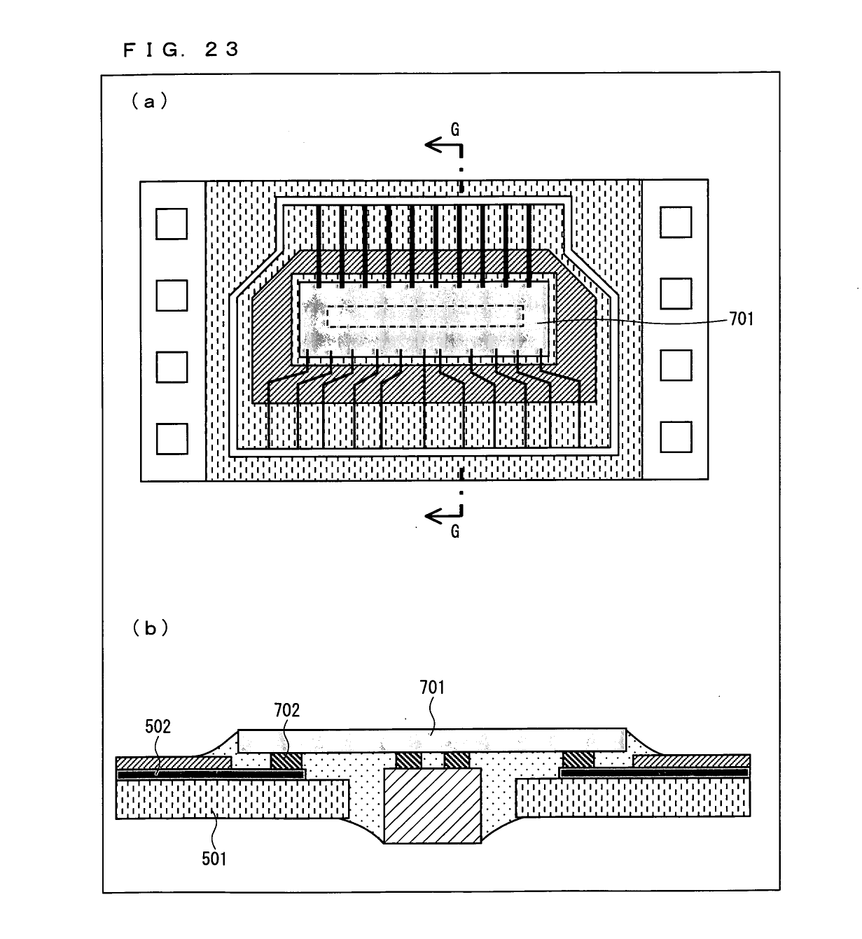

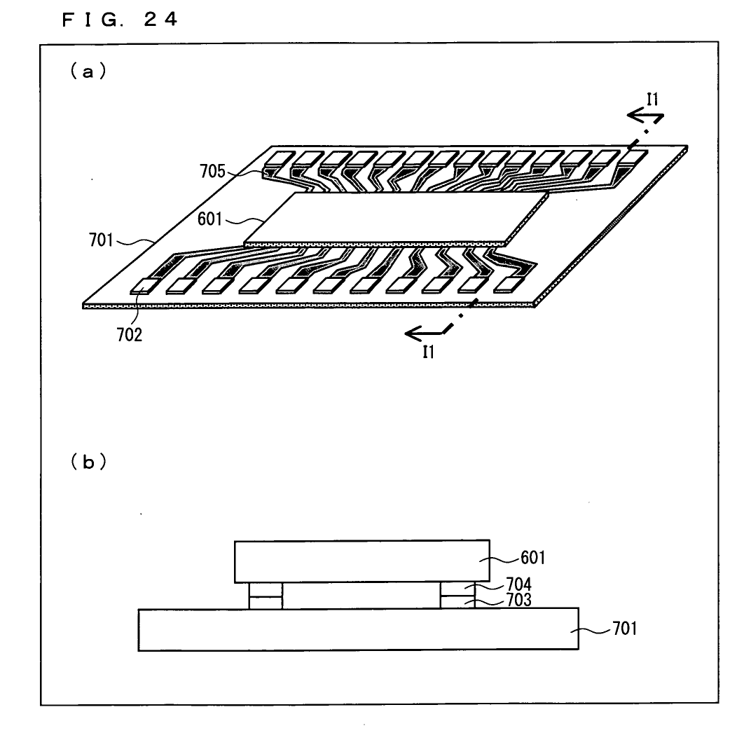

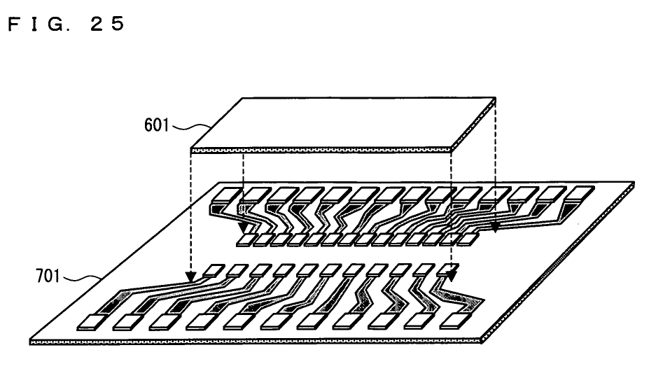

Terminals “CSVtypeA1R” to “CSVtypeA4R” (third terminals) and terminals “CSVtypeA1L” to “CSVtypeA4L” are input terminals of storage capacitor driving signals that are inputted from outside. Terminals “CSVtypeA1′” to “CSVtypeA4′” (first terminals) are output terminals of the storage capacitor driving signals, which are connected directly to storage capacitor wires (for example, storage capacitor wires 451 of FIG. 22), or which are connected to the storage capacitor wires via wiring or the like. These terminals are capable of supplying the storage capacitor driving signals to the connected storage capacitor wires.

Terminals “VCSH” and terminals “VCSL” are power supply terminals to which a power supply not illustrated is connected, for operating the buffer 22. A power supply voltage of the terminal “VCSH” is higher than a power supply voltage of the terminal “VCSL”.

Terminals “OVCSH” and terminals “OVCSL” are power supply terminals to which a power supply not illustrated is connected, for operating the buffer 22. In the embodiment, a power supply voltage applied to the terminals “OVCSH” is set several V higher than the power supply voltage of the terminals “VCSH”, and a power supply voltage applied to the terminals “OVCSL” is set several V lower than the power supply voltage applied to the terminals “VCSL”.

Terminals “CSVtypeA1R” to “CSVtypeA4R” provided in the gate driver 402 are connected to terminals “CSVtypeA1L” to “CSVtypeA4L” provided in the gate driver 402. Moreover, an input terminal of the buffer 22 is provided between the terminals “CSVtypeA1R” to “CSVtypeA4R” provided in the gate driver 402 and the terminals “CSVtypeA1L” to “CSVtypeA4L” provided in the gate driver 402. An output terminal of the buffer 22 is connected to the terminals “CSVtypeA1′” to “CSVtypeA4′” provided in the gate driver 402.

Storage capacitor driving signals inputted in the gate driver mounted substrate 401 illustrated in FIG. 19 is inputted to the buffer 22 via the terminals “CSVtypeA1R” to “CSVtypeA4R” (or alternatively, the terminals “CSVtypeA1L” to “CSVtypeA4L”). The buffer 22 shapes waveforms of the inputted storage capacitor driving signals, and the waveform-shaped storage capacitor driving signals are outputted to the storage capacitor wires via the terminals “CSVtypeA1′” to “CSVtypeA4′”. The gate driver mounted substrate 401 supplies the storage capacitor driving signals reduced in waveform rounding to the storage capacitor wires as such, and drives the storage capacitors connected to the storage capacitor wires.

The buffer 22 is not an essential constituent of the display device in accordance with the present embodiment, and therefore can be omitted. In a case where the buffer 22 is omitted, the gate driver mounted substrate 401 has the terminals “CSVtypeA1′” to “CSVtypeA4′” connected between the terminals “CSVtypeA1R” to “CSVtypeA4R” and the terminals “CSVtypeA1L” to “CSVtypeA4L”, which all terminals are provided in the gate driver 402.

Each of the terminals “CSVtypeA1′” to “CSVtypeA4′” provided in the interposer substrate 403 has a plurality of terminals.

Moreover, as shown in FIG. 19, the terminals “CSVtypeA1′” to “CSVtypeA4′” provided in the interposer substrate 403 are provided appropriately between the terminals “OG1” to “OG272” provided in the interposer substrate 403. Moreover, as shown in FIG. 19, the terminals “CSVtypeA1′” to “CSVtypeA4′” provided in the interposer substrate 403 may be appropriately provided in sections excluding parts between the terminals “OG1” to “OG272” provided in the interposer substrate 403. That is to say, the terminals “CSVtypeA1′” to “CSVtypeA4′” provided in the interposer substrate 403 are provided so that at least one terminal is provided between the terminals “OG1” and “OG272” provided in the interposer substrate 403 (namely, between any two terminals of the plurality of terminals “OG1” to “OG272”). Further, the terminals “CSVtypeA1′” to “CSVtypeA4′” provided in the gate driver 402 are connected to all the respective terminals “CSVtypeA1′” to “CSVtypeA4′” provided on the interposer substrate 403, via wires 404 that are provided on the interposer substrate 403.

The buffer 22 of course may be the buffer 210 (see FIG. 2), or the buffer 220 (see FIG. 6). The aforementioned overshoot driving is carried out to the storage capacitor driving signals by the buffer 220. Hence, in the gate driver 402 illustrated in FIG. 19, an electric potential higher than a voltage to be outputted is once outputted at a rise of the storage capacitor driving signals by the overshooting process, and thereafter a target electric potential is outputted. Similarly, in the gate driver 402 illustrated in FIG. 19, an electric potential lower than a voltage to be outputted is once outputted at a fall of the storage capacitor driving signal by the overshooting process, and thereafter a target electric potential is outputted. Hence, it is possible to shorten a time required to charge the storage capacitor and liquid crystal capacitor, and shorten the time required to reach the target voltage. Further, with this configuration, the gate driver 402 illustrated in FIG. 19 can operate even if the driving time of the storage capacitor becomes short due to the increase in the number of the scanning lines. That is to say, in the gate driver 402 illustrated in FIG. 19, the storage capacitor is appropriately driven even when the driving time of the storage capacitor is shortened caused by the increase in the number of the scanning lines. This reduces unevenness in display luminance, thereby reducing unevenness in display.

Here, the overview of the principle of generating the scanning line driving signals in the gate driver 402 is similar to that of the gate driver 2 illustrated in FIG. 5, and furthermore, is similar to that of the gate driver 1 illustrated in FIG. 1.

Namely, the terminals “LBR” of the gate driver 402 illustrated in FIG. 19 receives control signals that switches the terminals “LBR” to the “H” state or the “L” state. Hence, a shifting direction of the bidirectional shift register 12 is determined in the gate driver 402, thereby determining a scanning direction of the scanning line driving signals. In the embodiment, the summary is described by assuming a case where the terminals “LBR” are made into the “H” state. In this case, the scanning direction of the scanning line driving signals outputted by the output circuit 14, that is, an order of the scanning lines to which the scanning line driving signals are supplied, is: the scanning line connected to the terminal “OG1”, the scanning line connected to the terminal “OG2”, . . . to the scanning line connected to the terminal “OG272”.

When scanning start signals generated based on the vertical sync signals are inputted to the terminal “GSPOI” of the gate driver 402, the bidirectional shift register 12 starts a shifting operation by synchronizing with driving clock signals inputted via the terminal “GCKOI” of the gate driver 402, and generates a first pulse which is a pulse signal, by the shifting operation. Signals generated based on horizontal sync signals are used as the driving clock signals.

The first pulse is converted in level by the level shifter 13 to a signal having an amplitude from the voltage vgl to the voltage vgh, and this signal is outputted to the scanning line connected to the terminal “OG1” from the output circuit 14 as a scanning line driving signal. Next, the bidirectional shift register 12 generates a second pulse which is a pulse signal different from the first pulse, by the shifting operation. This second pulse is converted in level by the level shifter 13 to a signal having an amplitude from the voltage vgl to the voltage vgh, and this signal is outputted to the scanning line connected to the terminal “OG2” from the output circuit 14 as a scanning line driving signal.

That is to say, the bidirectional shift register 12 generates a (n+1)th pulse that is a pulse signal different from a nth pulse, by the aforementioned shifting operation. This (n+1)th pulse is converted in level by the level shifter 13 to a signal having an amplitude from the voltage vgl to the voltage vgh, and this converted signal then is outputted to a scanning line connected to the terminal “OG(n+1)” from the output circuit 14 as a scanning line driving signal. Next, the bidirectional shift register 12 generates a (n+2)th pulse which is a pulse signal different from the (n+1)th pulse, by the shifting operation. Further, operations as such are carried out until a scanning line driving signal generated based on a pulse (272nd pulse) is outputted to a scanning line connected to the terminal “OG272”.

In the shifting operation in the bidirectional shift register 12, signals synchronizing with the horizontal sync signals are used. Therefore, the scanning line driving signals outputted from the terminals “OG1” to “OG272” drive one scanning line per one cycle of the horizontal sync signals.

Once the shifting operation terminates, that is, once a scanning line driving signal is outputted to the scanning line connected to the terminal “OG272”, the gate driver 402 outputs scanning start signals from the terminals “GSPIO”, and outputs driving clock signals from the terminals “GCKIO”. These scanning start signals and driving clock signals are inputted in the subsequent gate driver. Accordingly, the subsequent gate driver also starts the scanning line driving signal generation operation in the scanning line driving device as similar to the gate driver 402. For example, in a case where the gate driver 402 drives 272 scanning lines, the subsequent gate driver provides the scanning line driving signals to the scanning lines from the 273rd scanning line, 274th scanning line, 275th scanning line, and so on.

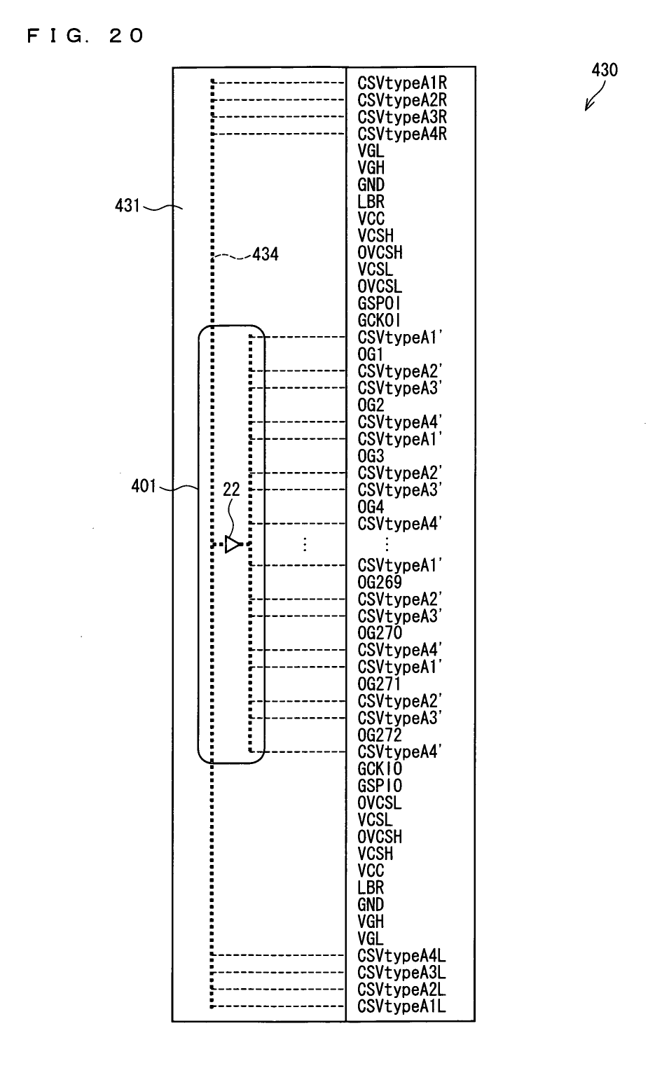

FIG. 20 is a view illustrating an outline of a scanning line driving device package including the gate driver mounted substrate 401. The gate driver mounted substrate 401 may be provided to the display device in the form of the scanning line driving device package 430 illustrated in FIG. 20, in a case where the gate driver mounted substrate 401 supplies the storage capacitor driving signals to storage capacitor wires provided in a display device driven by multi-picture element driving as like a liquid crystal display panel 440 illustrated in FIG. 22 later described, and also in a case where the gate driver mounted substrate 401 causes scanning line driving signals to be supplied to scanning lines provided in the display device.

In order to clearly illustrate the features according to the present embodiment, the scanning line driving device package 430 illustrated in FIG. 20 illustrates a member through which the storage capacitor driving signals pass, in a perspective manner.

The scanning line driving device package 430 illustrated in FIG. 20 includes a tape 431 on which the gate driver mounted substrate 401 is mounted.

In the scanning line driving device package 430 illustrated in FIG. 20, a terminal section has terminals of the display device provided corresponding to the terminals of the gate driver mounted substrate 401. The terminal section is a member in which terminals are given signs (letters) identical to the terminal names of the terminals provided in the gate driver mounted substrate 401 in the scanning line driving device package 430, and is a member provided on a right end part of the scanning line driving device package 430. Each of the terminals provided in the scanning line driving device package 430 illustrated in FIG. 20 are connected to a respective terminal provided in the gate driver mounted substrate 401 which has an identical terminal name. Hence, this makes it possible for the scanning line driving device package 430 illustrated in FIG. 20 to output signals or a voltage to be outputted from the gate driver mounted substrate 401 externally of the scanning line driving device package 430. Moreover, for convenience, FIG. 20 illustrates a plurality of wires through which the storage capacitor driving signals pass (for example, wiring 434 connecting the terminal “CSVtypeA1R” and the terminal “CSVtypeA1L”) and wires around the wiring, as one bold line.

The scanning line driving device package 430 is provided in such a manner that the terminals “OG1” to “OG272” are positioned around a middle part of the terminal section, and that the terminals “CSVtypeA1′” to “CSVtypeA4′” are appropriately provided between the terminals “OG1” to “OG272” (and, on both sides of the terminals “OG1” to “OG272”). Other terminals are positioned closer to edge sections of the terminal section than the terminals “OG1” to “OG272”. The terminals “CSVtypeA1R” to “CSVtypeA4R” of the terminal section are connected to the terminals “CSVtypeA1L” to “CSVtypeA4L” of the terminal section by use of the wiring 434 provided on the tape 431 and the gate driver mounted substrate 401. Moreover, although not illustrated, with the terminals “VGL”, terminals “VGH”, terminals “GND”, terminals “LBR”, terminals “VCC”, terminals “VCSH”, terminals “VCSL”, terminals “OVCSH”, and terminals “OVCSL”, each of which are provided by two in the terminal section, one of the two terminals are connected to the other of the two terminals via the terminal provided in the gate driver mounted substrate 401 that has its identical terminal name. The terminal “GSPOI” and terminal “GSPIO” have an input-output relation, in which when one is an input terminal, the other serves as an output terminal. Namely, one terminal of the terminal “GSPOI” and the terminal “GSPIO” input signals and the other terminal outputs this inputted signal. The terminal “GSPOI” and terminal “GSPIO” are suitably positioned on both ends of the terminal section. Moreover, the terminal “GCKOI” and terminal “GCKIO” are similarly suitably positioned on both ends of the terminal section.

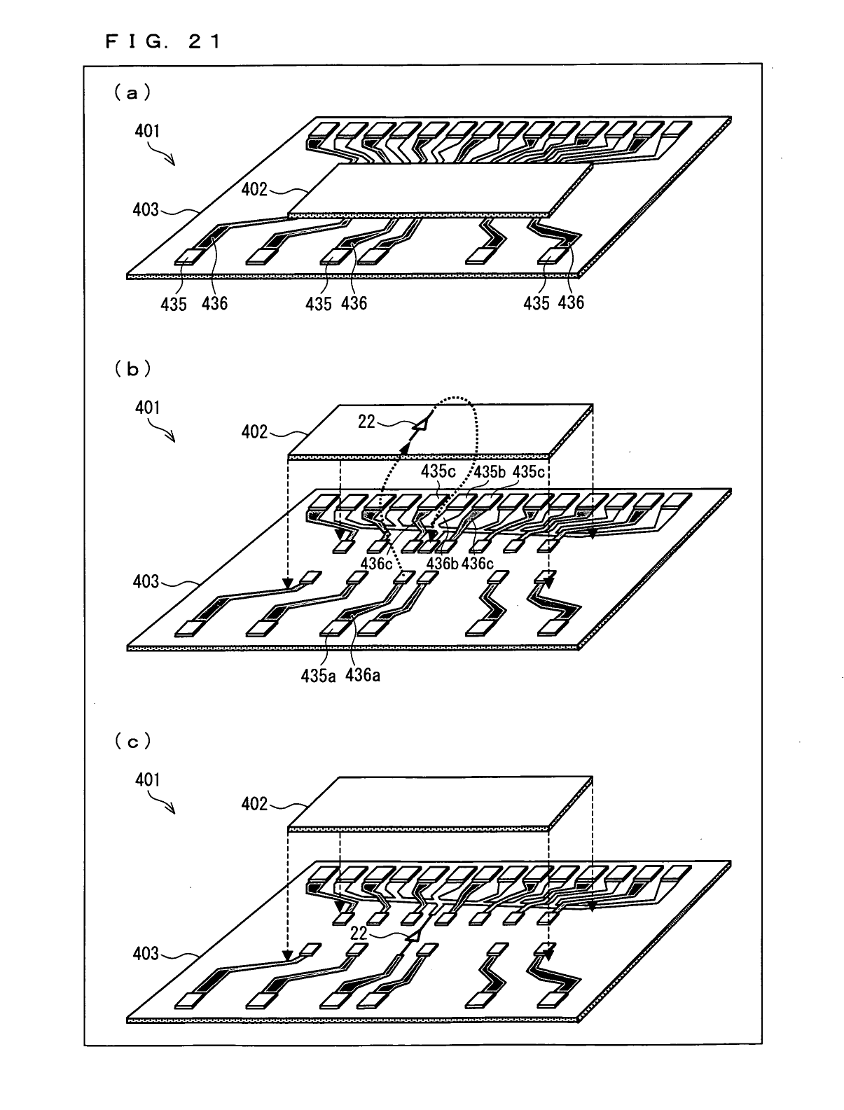

Moreover, FIG. 21 is a view schematically illustrating the gate driver mounted substrate 401. More specifically, (a) of FIG. 21 is a perspective view illustrating a state in which the gate driver 402 is mounted on the interposer substrate 403, (b) of FIG. 21 is a perspective view illustrating how the gate driver 402 is mounted on the interposer substrate 403, and (c) of FIG. 21 illustrates a perspective view of a state in which the buffer 22 driving the storage capacitor driving signal is provided on the interposer substrate 403.

As illustrated in (a) of FIG. 21, the interposer substrate 403 has terminal-substrate bumps 435 to be connected to film terminals not illustrated, and substrate wires 436 provided on the interposer substrate 403. The gate driver 402 and the terminal-substrate bumps 435 are connected via the substrate wires 436.

The terminal-substrate bumps 435a on an input side are input terminals of the storage capacitor driving signals in the gate driver mounted substrate 401, that is, the terminals “CSVtypeA1R” to “CSVtypeA4R” and the terminals “CSVtypeA1L” to “CSVtypeA4L”, of the interposer substrate 403 (see FIG. 19). The wiring 434 (see FIG. 20) is connected to the terminal-substrate bumps 435a on the input side, and the terminal-substrate bumps 435a are connected to the input terminals of the storage capacitor driving signals in the gate driver 402, that is, the terminals “CSVtypeA1R” to “CSVtypeA4R” and the terminals “CSVtypeA1L” to “CSVtypeA4L”, of the gate driver 402 (see (b) of FIG. 21). For convenience, just one terminal of the input terminals of the storage capacitor driving signals in the gate driver mounted substrate 401 is illustrated and illustration of the input terminals of the storage capacitor driving signals in the gate driver 402 is omitted, in (b) of FIG. 21. However, it is needless to say that such input terminals are provided in the gate driver 402 or interposer substrate 403 by the number equal to a total number of the terminals “CSVtypeA1R” to “CSVtypeA4R” and the terminals “CSVtypeA1L” to “CSVtypeA4L” provided in the gate driver 402 or interposer substrate 403.

The input terminals of the storage capacitor driving signals in the gate driver 402 are connected to the input terminals of the buffer 22 inside the gate driver 402, and the output terminals of the buffer 22 are connected to the terminals “CSVtypeA1′” to “CSVtypeA4′” of the gate driver 402 not illustrated (see (b) of FIG. 21). The terminals “CSVtypeA1′” to “CSVtypeA4′” of the gate driver 402 and the bumps 435b on an output side of the interposer substrate 403 are connected via the substrate wires 436b. However, since the bumps 435b are provided between pads (bumps) 435c through which the scanning line driving signals pass, it is necessary to have the substrate wires 436b through which the storage capacitor driving signals pass intersect with the substrate wires 436c through which the scanning line driving signals pass. Hence, the substrate wires 436b through which the storage capacitor driving signals pass and the substrate wires 436c through which the scanning line driving signals pass are formed on different layers in such a manner that the two types of wires intersect with each other on the interposer substrate 403.

The buffer 22 for driving the storage capacitor driving signals may be, as illustrated in (c) of FIG. 21, provided on the interposer substrate 403.

The interposer substrate 403 is manufactured in an identical step as a step of manufacturing the integrated circuit. Hence, it is possible to make a wiring layer into two layers, and to provide a buffer.

FIG. 22 is a view illustrating a state in which the scanning line driving device package 430 is mounted on a substrate of a display device.

In order to clearly illustrate the features according to the present embodiment, members through which the storage capacitor driving signals pass are illustrated in a perspective manner, in the liquid crystal display panel (display device) 440 illustrated in FIG. 22.

Moreover, FIG. 22 describes a liquid crystal display panel 440 that mounts two scanning line driving device packages 430 on a display device, as the display device according to the present embodiment. However, the present invention is not limited to this arrangement. Namely, just one of the scanning line driving device package 430 may be mounted on the substrate of the liquid crystal display panel 440, or three or more thereof may be mounted.

The following description explains a configuration and principle of operation of the display device according to the present embodiment, with reference to FIG. 22.

As shown in FIG. 22, in the liquid crystal display panel 440, one display picture element 441 is divided into a plurality of sub-picture elements, 442 and 443. The sub-picture element 442 is connected to a scanning line Gn and a signal line (data line) Sm, via a TFT 444. Further, the sub-picture element 443 is connected to the scanning line Gn and the signal line Sm, via a TFT 445. That is to say, gate electrodes of the TFT 444 and TFT 445 are connected to the common (identical) scanning line Gn. Moreover, source electrodes of the TFT 444 and TFT 445 are connected to the common (identical) signal line Sm.

Each of the sub-picture elements 442 and 443 has a liquid crystal capacitor and a storage capacitor. Each of the liquid crystal capacitors and storage capacitors is provided in such a manner that one electrode thereof is connected to a drain electrode of the respective TFT 444 and TFT 445. The other one of the electrodes of each of the liquid crystal capacitors is connected to a counter voltage. The other one of the electrodes of each of the storage capacitors is connected to a respective storage capacitor wire 446 or 447. This allows application of a CS voltage to the storage capacitors of the sub-picture elements 442 and 443, from the respective storage capacitor wires 446 and 447. Namely, the sub-picture elements 442 and 443 have a similar connection relationship as the sub-picture elements 121 and 122 illustrated in FIG. 12. Therefore, a CS voltage applied to the storage capacitor in the sub-picture element 442 and a CS voltage applied to the storage capacitor in the sub-picture element 443 may be of a different voltage.

That is to say, the display picture element 441 illustrated in FIG. 22 has a similar configuration as the display picture element 120 illustrated in FIG. 12.

In the liquid crystal display panel 440, first, storage capacitor driving signals, control signals of a gate driver which serves as basis of scanning line driving signals (scanning start signals and driving clock signals), and various power supply voltages are inputted from a controller not illustrated to a scanning line driving device package 430A having an identical configuration as the scanning line driving device package 430. Here, the terminals “LBR” are connected to the terminals “VCC”, and thereby the terminals “LBR” are fixed as the “H” state. The scanning line driving device package 430A receives the storage capacitor driving signals via the terminals “CSVtypeA1R” to “CSVtypeA4R”. Moreover, since the terminals “LBR” are in the “H” state, the control signals of the gate driver are inputted from the terminal “GSPOI” and terminal “GCKOI”. Moreover, various power supply voltages are inputted via the terminals “VGL”, terminals “VGH”, terminals “GND”, terminals “VCC”, terminals “VCSL”, terminals “VCSH”, terminals “OVCSL”, and terminals “OVCSH”.

Here, in FIG. 22, the terminals “LBR”, terminals “VGL”, terminals “VGH”, terminals “GND”, terminals “VCC”, terminals “VCSL”, terminals “VCSH”, terminals “OVCSL”, and terminals “OVCSH” are connected to respective terminals that have an identical terminal name. Moreover, as shown in FIG. 22, the terminal “GSPOI” is connected to the terminal “GSPIO”, and the terminal “GCKOI” is connected to the terminal “GCKIO”.

Similarly, as shown in FIG. 22, the terminals “CSVtypeA1R” to “CSVtypeA4R” are connected to the terminals “CSVtypeA1L” to “CSVtypeA4L”, respectively.

Therefore, by connecting the terminals “CSVtypeA1L” to “CSVtypeA4L” provided in the scanning line driving device package 430A with the respective terminals “CSVtypeA1R” to “CSVtypeA4R” provided in the scanning line driving device package 430B having an identical configuration as the scanning line driving device package 430A, it is possible to supply, to the scanning line driving device package 430B, the storage capacitor driving signals, the control signals of the gate driver, and various power supply voltages that are inputted to the scanning line driving device package 430A from the scanning line driving device package 430A, in the liquid crystal display panel 440.

Next, in the liquid crystal display panel 440, the scanning line driving device package 430A generates scanning line driving signals by the aforementioned principle, with use of signals inputted from the controller which signals serve as the basis of the scanning line driving signals. Terminals “OG1” to “OG272” of the scanning line driving device package 430A are connected to respective scanning lines Gn of the liquid crystal display panel 440. The scanning line driving device package 430A provides the scanning line driving signals to each of the scanning lines Gn connected to the terminals “OG1” to “OG272”.

On the other hand, the storage capacitor driving signals inputted from the controller to the terminals “CSVtypeA1R” to “CSVtypeA4R” are outputted from the terminals “CSVtypeA1′” to “CSVtypeA4′”, via the buffer 22 provided in the gate driver mounted substrate 401 of the scanning line driving device package 430A. The terminals “CSVtypeA1′” to “CSVtypeA4′” of the scanning line driving device package 430A are connected to respective storage capacitor wires 451. Storage capacitor driving signals outputted from the buffer 22 and which are reduced in waveform rounding are provided to all of the storage capacitor wires 451 connected to the terminals “CSVtypeA1′” to “CSVtypeA4′” of the scanning line driving device package 430A. These storage capacitor driving signals drives the storage capacitor that is connected to the storage capacitor wires 451.

The display device according to the present embodiment requires no core wiring to be provided for a whole liquid crystal display panel, as with the display device according to a conventional technique. Hence, with the display device according to the present embodiment, it is possible to narrow its frame.

The display device according to the present embodiment may be arranged so that the storage capacitor driving signals are generated inside the scanning line driving device, and such generated signals are supplied to each of storage capacitor wires from the scanning line driving device.

Moreover, the description of the present embodiment is dealt with by using an example in which the gate driver 2 illustrated in FIG. 5 is used as the gate driver 402 of the gate driver mounted substrate 401 illustrated in FIG. 19. However, the present embodiment is not limited to this example, and the gate driver 1 illustrated in FIG. 1 or the gate driver 3 illustrated in FIG. 9 may also be used as the gate driver 402.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

The present invention is suitably used for a display device used in for example a word processor, a personal computer, and a receiver of a television broadcast. Particularly, the present invention is suitably used for a display device of an active matrix liquid crystal display device or the like, and a scanning line driving device provided in such a display device for driving scanning lines.

1. A display device comprising:
a scanning line driving device or scanning line driving devices; and
a plurality of sub-picture elements, one display picture element being divided into the plurality of sub-picture elements,
each of the plurality of sub-picture elements having a storage capacitor that is connected to a respectively different one of storage capacitor wires,
the storage capacitors being driven in accordance with storage capacitor driving signals supplied to the storage capacitor wires, to allow display of the plurality of sub-picture elements in such a manner that each of the plurality of sub-picture elements are displayed having a different luminance from each other,
the scanning line driving device or scanning line driving devices comprising:
at least one first buffer for (i) shaping waveforms of the storage capacitor driving signals to be supplied to the storage capacitor wires, the storage capacitor driving signals being received by the at least one first buffer, and (ii) supplying the storage capacitor driving signals thus shaped to the storage capacitor wires.

2. The display device according to claim 1, wherein:
the scanning line driving device or scanning line driving devices further comprises:
wires for outputting the storage capacitor driving signals to be supplied to the storage capacitor wires as supplied, to a destination outside the scanning line driving device, the destination being different from the storage capacitor wires.

3. The display device according to claim 2, wherein:
the scanning line driving devices are connected to each other via the wires.

4. The display device according to claim 3, wherein:
the storage capacitor wires are connected to the at least one first buffer of a respective one of the scanning line driving devices, and are provided in divisions according to the respective one of the scanning line driving devices.

5. The display device according to claim 1, wherein:
the at least one first buffer included in the scanning line driving device or scanning line driving devices is a plurality of buffers.

6. The display device according to claim 5, wherein:
the storage capacitor wires are connected to a respective one of the plurality of first buffers, and are provided in divisions according to their connected first buffer.

7. The display device according to claim 1, wherein:
the at least one first buffer of the scanning line driving device or scanning line driving devices supplies the received storage capacitor driving signals to the storage capacitor wires by overshoot driving.

8. A display device according to claim 1, wherein:
the scanning line driving device or scanning line driving devices further comprises:
a second buffer for (i) shaping waveforms of the storage capacitor driving signals to be supplied to the storage capacitor wires, the storage capacitor driving signals being received by the second buffer, and (ii) outputting the storage capacitor driving signals thus shaped to a destination outside the scanning line driving device or scanning line driving devices, the destination being different from the storage capacitor wires.

9. The display device according to claim 8, wherein:
the scanning line driving devices are provided in series, to have a plurality of stages,
the second buffer of each of the scanning line driving devices that are provided previously to a scanning line driving device of a last stage being connected to the first buffer of a corresponding scanning line driving device provided in a subsequent stage of said each of the scanning line driving devices.

10-11. (canceled)

12. The display device according to claim 1, further comprising:
a scanning wiring made up of a plurality of scanning lines,
the scanning line driving device or scanning line drive devices driving the plurality of scanning lines in accordance with scanning line driving signals that are supplied to each of the plurality of scanning lines,
the scanning line driving device further comprising:
a plurality of first terminals for supplying to the storage capacitor wires the storage capacitor driving signals to be supplied to the storage capacitor wires; and
a plurality of second terminals for supplying to the scanning lines scanning line driving signals to be supplied to the scanning lines,
any one or two or more of the plurality of first terminals being provided between any two terminals of the plurality of second terminals.

13. The display device according to claim 12, wherein:
the scanning line driving device further comprises third terminals via which the storage capacitor driving signals to be supplied to the storage capacitor wires are inputted from outside the scanning line driving device,
the third terminals being connected to the plurality of first terminals, respectively.

14. The display device according to claim 12, wherein:
the scanning line driving device comprises:
a substrate having the plurality of first terminals, the plurality of second terminals, and third terminals via which the storage capacitor driving signals to be supplied to the storage capacitor wires are inputted from outside the scanning line driving device; and
an integrated circuit for generating the scanning line driving signals and supplying the generated scanning line driving signals to the plurality of second terminals.

15. The display device according to claim 13, further comprising:
a buffer provided between the third terminals and the plurality of first terminals, for (i) shaping waveforms of the storage capacitor driving signals to be supplied to the storage capacitor wires via the third terminals and (ii) outputting the storage capacitor driving signals thus shaped to the plurality of first terminals.

16. The display device according to claim 14, wherein:
the integrated circuit includes a buffer for (i) shaping waveforms of the storage capacitor driving signals to be supplied to the storage capacitor wires, the storage capacitor driving signals being received by the buffer, and (ii) outputting the storage capacitor driving signals thus shaped,
the buffer having an input terminal connected to the third terminals and an output terminal connected to the plurality of first terminals.

17. The display device according to claim 14, wherein:
the substrate includes a buffer for (i) shaping waveforms of the storage capacitor driving signals to be supplied to the storage capacitor wires, the storage capacitor driving signals being received by the buffer, and (ii) outputting the storage capacitor driving signals thus shaped,
the buffer having an input terminal connected to the third terminals, and an output terminal connected to the plurality of first terminals.

18. The display device according to claim 15, wherein:
the buffer outputs the received storage capacitor driving signals by overshoot driving.

19. A scanning line driving device provided in a display device for driving scanning lines that are provided in the display device, the display device including a plurality of sub-picture elements, one display picture element being divided into the plurality of sub-picture elements, each of the plurality of sub-picture elements having a storage capacitor that is connected to a respectively different one of storage capacitor wires, the storage capacitors being driven in accordance with storage capacitor driving signals supplied to the storage capacitor wires, to allow display of the plurality of sub-picture elements in such a manner that each of the plurality of sub-picture elements are displayed having a different luminance from each other,
the scanning line driving device comprising:
a buffer for (i) shaping waveforms of the storage capacitor driving signals to be supplied to the storage capacitor wires, the storage capacitor driving signals being received by the buffer, and (ii) supplying the storage capacitor driving signals thus shaped to the storage capacitor wires.

20. The scanning line driving device according to claim 19, further comprising:
wires for outputting the storage capacitor driving signals to be supplied to the storage capacitor wires as supplied, to a destination outside the scanning line driving device, the destination being different from the storage capacitor wires.

21. The scanning line driving device according to claim 19, wherein:
the buffer supplies the received storage capacitor driving signals to the storage capacitor wires by overshoot driving.

22. A scanning line driving device provided in a display device for driving scanning lines that are provided in the display device, the display device including a plurality of sub-picture elements, one display picture element being divided into the plurality of sub-picture elements, each of the plurality of sub-picture elements having a storage capacitor that is connected to a respectively different one of storage capacitor wires, the storage capacitors being driven in accordance with storage capacitor driving signals supplied to the storage capacitor wires, to allow display of the plurality of sub-picture elements in such a manner that each of the plurality of sub-picture elements are displayed having a different luminance from each other,
the scanning line driving device comprising:
a first buffer for (i) shaping waveforms of the storage capacitor driving signals to be supplied to the storage capacitor wires, the storage capacitor driving signals being received by the first buffer, and (ii) supplying the storage capacitor driving signals thus shaped to the storage capacitor wires; and
a second buffer for (i) shaping waveforms of the storage capacitor driving signals to be supplied to the storage capacitor wires, the storage capacitor driving signals being received by the second buffer, and (ii) outputting the storage capacitor driving signals thus shaped to a destination outside the scanning line driving device, the destination being different from the storage capacitor wires.

23. The scanning line driving device according to claim 22, wherein:
the first buffer supplies the received storage capacitor driving signals to the storage capacitor wires by overshoot driving.

24. (canceled)
